(19) United States
(12) Patent Application Publication
(10) Pub. No.: US 2016/0132456 A1
(43) Pub. Date: May 12, 2016

(54) INTEGRATED ADAPTER FOR THIN COMPUTING DEVICES

(71) Applicants: Allied Telesis Holdings Kabushiki Kaisha, Tokyo (JP); Allied Telesis, Inc., Bothell, WA (US)

(72) Inventor: Douglas D. Barga, Bellevue, WA (US)

(21) Appl. No.: 14/538,674

(22) Filed: Nov. 11, 2014

(51) Int. Cl. G06F 13/42; G06F 1/26; G06F 13/40

(52) U.S. Cl. CPC G06F 13/4221; G06F 13/4068; G06F 1/26

(57) ABSTRACT

A system and method for facilitating communication. The system includes an adapter card and a motherboard interface for coupling the adapter card to a motherboard. In some embodiments, the adapter card comprises an optical transmitter. In some embodiments, the motherboard interface is configured to transmit data between the adapter card and the motherboard. In some embodiments, the motherboard interface is configured to supply power from the motherboard to the adapter card. In some embodiments, the motherboard interface is a mini PCI express interface. The system may further comprise an external interface for coupling the adapter card to an external environment of a system associated with the motherboard. In some embodiments, the external interface is configured to transmit data between the external environment of the system and the adapter card.

### RELATED U.S. APPLICATIONS

This application is related to U.S. patent application Ser. No. 13/915,380 entitled “ADAPTER CARD FOR THIN COMPUTING DEVICES”, by Douglas D. Barga. (Attorney Docket No. 13-005-00-US) which is incorporated by reference herein.

This application is related to U.S. patent application Ser. No. ______, entitled “ADAPTER CARD FOR THIN COMPUTING DEVICES”, by Douglas D. Barga. (Attorney Docket No. 13-053-00-US) which is incorporated by reference herein.

### BACKGROUND

As computing devices are made increasingly smaller, the number of slots for expansion cards, which increase the capabilities of a thin client device, is reduced and/or the slots eliminated completely. This is particular visible in thin client devices which not only fewer slots but also less physical space for expansion cards. Unfortunately, this reduction in slots and space results in a reduction or elimination of features supported by expansion cards e.g., fiber cards, graphic cards, etc.

### SUMMARY

A need has arisen for a solution to provide functionalities of expansion cards supported by PCI slots in the absence of PCI slots. For example, there is a need to provide adapter cards in a thin client device without PCI slots or with a reduced number of PCI slots where the adapter cards are incorporated within the thin client without using the PCI slots. Further, a need has arisen to have an adapter card mounted in an available area of the thin client computing device.

Embodiments allow the use of one or more otherwise unused motherboard slots for communication with an external environment. For example, embodiments allow use of a motherboard interface operable for a wireless card to be used for wired (e.g., electrical, optical, etc.) communication. In some embodiments, a Mobile PCI Express Module (MXM) interface is used for physical coupling of an adapter card while a mini PCI express interface is used for communications with a motherboard. As another example, embodiments may allow use of a mini PCI express slot for fiber optic communications. Further, some embodiments are substantially located on a single board (e.g., printed circuit board, express miniboard, etc.) thereby having reduced points of failure.

An embodiment is directed to a device for facilitating communication. The device includes an adapter card and a motherboard interface for coupling the adapter card to a motherboard. In some embodiments, the adapter card comprises an optical transmitter. In some embodiments, the optical transmitter is a portion of an optical transceiver of the adapter card. In some embodiments, the adapter card is configured for communication via a fiber optic cable. In some embodiments, the adapter card has substantially a Mini PCI express card form factor. In some embodiments, the adapter card includes a network data transmitter module configured to communicate networking data between the external environment of the system and the adapter card via emitting light signals. In some embodiments, a portion of the adapter card extends beyond a standard mini PCI express card form factor.

In some embodiments, the motherboard interface is configured to transmit data between the adapter card and the motherboard. In some embodiments, the motherboard interface is configured to supply power from the motherboard to the adapter card. In some embodiments, the motherboard interface is a mini PCI express interface. The device may further comprise an external interface for coupling the adapter card to an external environment of a system associated with the motherboard. In some embodiments, the external interface is configured to transmit data between the external environment of the system and the adapter card. In some embodiments, the adapter card comprises an operating mode detection unit configured to determine an operating state of the motherboard. In some embodiments, the adapter card is configured to determine whether to perform a wake on local access network (WoL) operation. In some embodiments, the adapter card is configured to determine whether the motherboard is in an on state or an off state. In some embodiments, the adapter card is further configured to initiate the wake on local access network (WoL) operation in response to determining that the motherboard is in the off state.

Another embodiment is directed to a method for facilitating communication. The method includes receiving power from a motherboard to supply power an adapter card and communicating data between the motherboard and the adapter card of a device via a mini PCI express interface. The method may further include communicating data between the adapter card and an external environment to a system associated with the motherboard via an optical transceiver. In some embodiments, the adapter card has substantially a Mini PCI express card form factor. In some embodiments, a portion of the adapter card extends beyond a standard mini PCI express card form factor. In some embodiments, the method may further include emitting light signals to communicate networking data between the adapter card and the external environment. In some embodiments, the method further includes determining an operating state associated with the motherboard and determining whether to perform a wake on local access network (WoL) operation based on the operating state. In some embodiments, the method further includes determining whether a first voltage or a second voltage is present at the motherboard coupled to a motherboard interface and initiating a wake on local access network (WoL) operation in response to determining the presence of the second voltage.

Another embodiment is directed to a system for facilitating communication. The system includes a peripheral component and a mini PCI express interface configured to couple the peripheral component to the motherboard. In some embodiments, the peripheral component facilitates communication between a system and an external environment via an optical transceiver. In some embodiments, the system comprises a motherboard associated with the system. In some embodiments, the external environment is an environment external to the system. In some embodiments, the peripheral component is of a substantially mini PCI express form factor. In some embodiments, the mini PCI express interface is configured to communicate data between the peripheral component and the motherboard. In some embodiments, the mini PCI express interface is configured to supply power to the peripheral component.

In some embodiments, an adapter card may be coupled to an external interface without using a PCI slot. The external interface facilitates data communication between the adapter card and the external environment of the thin client. In some embodiments, the external interface may include internal media cables, such as fiber optic cables, and connectors. The connectors may couple the internal media cables with external cables of the thin client device to facilitate communication between the adapter card and the external environment. As such, the adapter card facilitates communication with an external environment without using a PCI slot.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows a computing device configured to house an adapter card in accordance with some embodiments.

FIG. 2 shows a computing device configured to house a network adapter in accordance with some embodiments.

FIG. 3 shows an external interface in accordance with some embodiments.

FIG. 4 shows an operating mode detection unit in accordance with some embodiments.

FIG. 5 shows an operating mode detection unit and a controller in accordance with some embodiments.

FIG. 6 shows an illustrative flow diagram for data communication of an adapter card in accordance with some embodiments.

FIG. 7 shows an illustrative flow diagram to determine an operational state of a computing device to initiate a wake on local access network (WoL) operation in accordance with some embodiments.

FIG. 8 shows a computing device configured to house an adapter card in accordance with some embodiments.

FIGS. 9A-B show a network adapter in accordance with some embodiments.

FIG. 10 shows a computing device and a network adapter in accordance with some embodiments.

FIG. 11 an illustrative flow diagram for data communication of an adapter card in accordance with some embodiments.

FIG. 12 shows an illustrative adapter card in accordance with some embodiments.

FIG. 13 shows illustrative components of an adapter card in accordance with some embodiments.

FIGS. 14A-B show an illustrative top view and an illustrative bottom view of an adapter card layout in accordance with some embodiments.

FIG. 15 an illustrative flow diagram for data communication of an adapter card in accordance with some embodiments.

FIG. 16 shows a block diagram of a computer system in accordance with some embodiments.

FIG. 17 shows a block diagram of another computer system in accordance with some embodiments.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description of various embodiments, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits have not been described in detail as not to unnecessarily obscure aspects of the claimed embodiments.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “converting,” “transmitting,” “storing,” “determining,” “sending,” “querying,” “providing,” “accessing,” “associating,” “configuring,” “initiating,” “customizing”, “mapping,” “modifying,” “generating,” “communicating,” “transmitting,” “emitting,” “changing,” “processing,” “computing,” “adjusting,” “configuring,” “performing,” “maintaining,” “enabling,” “disabling,” “communicating,” or the like, may refer to actions and processes of a computer system or similar electronic computing device or processor. The computer system or similar electronic computing device manipulates and transforms data represented as physical (e.g., electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. In some embodiments, the present systems and methods can be implemented as hardware components, e.g., an application specific integrated circuit (ASIC), a field-programmable gate array (FPGA), complex programmable logic device (CPLD), a Programmable Array Logic (PAL) device, Generic Array Logic (GAL) device, embedded device, microcontroller, programmable device, etc. Some embodiments may include a computing device, a network device, etc., configured for implementing the present systems and methods. For example, some embodiments may be implemented as a router, a switch, etc. By way of example, and not limitation, computer-readable storage media may comprise computer storage media and communication media. Generally, program modules include routines, programs, objects, components, data structures, etc., that perform specific tasks or implement specific abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

A need has arisen for a solution to provide functionalities of expansion cards supported by PCI slots in the absence of PCI slots. For example, there is a need to provide adapter cards in a thin client device without PCI slots or with a reduced number of PCI slots where the adapter cards are incorporated within the thin client without using the PCI slots. Further, a need has arisen to have an adapter card mounted in an available area of the thin client computing device.

Embodiments allow the use of one or more otherwise unused motherboard slots for communication with an external environment. For example, embodiments allow use of a motherboard interface operable for a wireless card to be used for wired (e.g., electrical, optical, etc.) communication. In some embodiments, a Mobile PCI Express Module (MXM) interface is used for physical coupling of an adapter card while a mini PCI express interface is used for communications with a motherboard. As another example, embodiments may allow use of a mini PCI express slot for fiber optic communications. Further, some embodiments are substantially located on a single board (e.g., printed circuit board, express miniboard, etc.) thereby having reduced points of failure.

Embodiments allow for the incorporation of functionalities of PCI based components within a computing system with few or no PCI slots. Further, embodiments enable such functionalities in computing systems with an occupied hard disk drive area. For example, embodiments may include an adapter card configured for being physically, but not communicatively coupled with a Mobile PCI Express Module (MXM) slot, while the adapter card is communicatively coupled with a Mini PCI Express slot.

In some embodiments described herein, the adapter card may be coupled to a motherboard interface, such as an express miniboard or mini PCI express interface, that facilitates communication between a motherboard and the adapter card. The motherboard interface may provide an alternative to a PCI communication bus of a PCI slot to transmit data between the motherboard and the adapter card. In this way, the motherboard interface provides a mechanism that allows features of the adapter card to be incorporated into a computing device without the use of a PCI slot.

Some modifications may need to be made to the adapter card to provide the functionalities supported by PCI slots without using the PCI slots. For example, the adapter card may include a wake on local area network (WoL) unit to support an WoL feature. In some embodiments, the WoL unit may be configured to determine the amount of voltage supplied by the motherboard interface, change the voltage as required, determine the operating state of a device, and initiate a WoL operation accordingly. In some embodiments, the adapter card may be coupled to an external interface different from a PCI slot. The external interface may be configured to transmit data between the external environment and the adapter card. In some embodiments, the external interface may comprise of media cables and connectors that may be connected to external cables, such as fiber optic cables or Ethernet cables, to facilitate communication between the adapter card and the external environment without using a PCI slot.

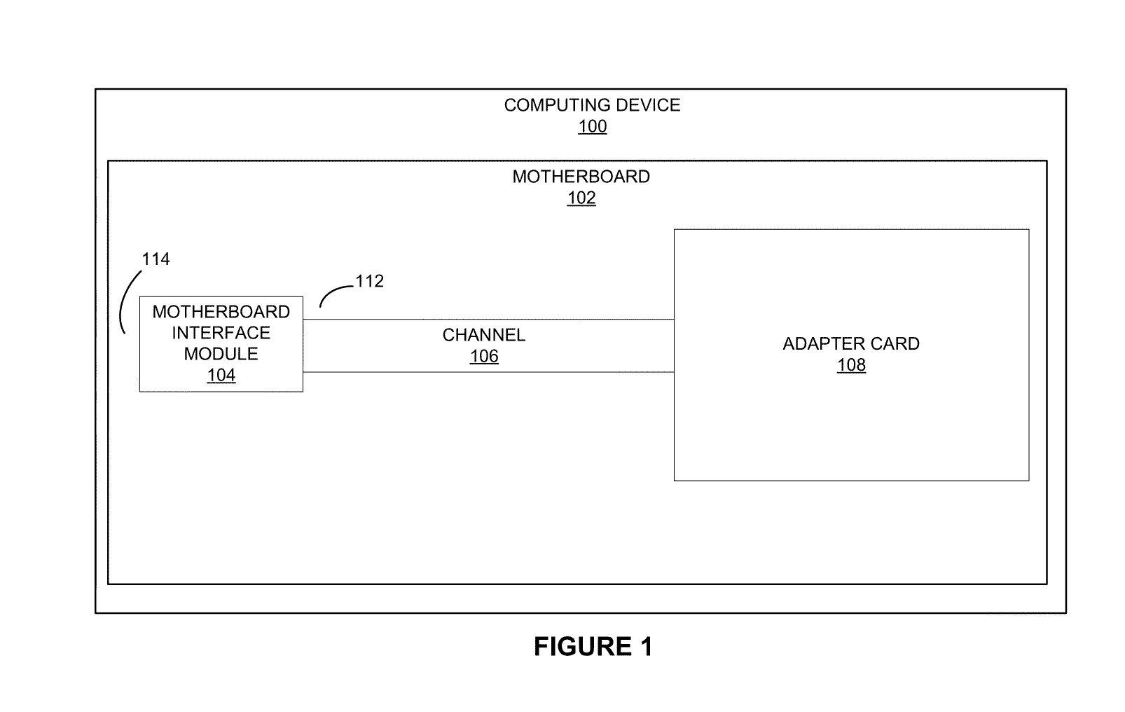

Referring now to FIG. 1, a computing device configured to house an adapter card according to one embodiment is shown. In some embodiments, computing device 100 may be a thin client device with reduced number of PCI slots, e.g., fewer than two PCI slots. Although many of the features are illustrated with reference to PCI slots, it is appreciated that the discussion of PCI slots is illustrative and is not intended to limit the scope of the embodiments. For example, in some embodiments, the features described herein may be applicable to thin clients with reduced number of PCI express (PCIe) slots, PCI-X slots, or any other expansion slots. The adapter cards according to some embodiments may use appropriate protocols of the corresponding slot, e.g., PCI slots, PCI-X slots, PCIe slots, or any other expansion slots, to enable the adapter card to function as if it was inserted into the PCI slot even though it is not.

In some embodiments, the computing device 100 includes a motherboard 102, a motherboard interface module 104, a channel 106, and an adapter card 108. Although FIG. 1 illustrates a few components of the computing device 100, it is appreciated that computing device 100 may include other components (not shown) to ensure proper functionality.

In some embodiments, the computing device 100 is configured to house an adapter card 108 and incorporate the features of adapter card 108 without inserting the adapter card 108 in a PCI slot. In some embodiments, the adapter card 108 may be a fiber optics adapter, a graphics card, a network adapter, a sound card, or any peripheral component.

Instead of inserting the adapter card 108 into a PCI slot, the adapter card 108 may be housed in a different location within the computing device 100. In some embodiments, the adapter card 108 is housed in an unused or underutilized location of the computing device. For example, a conventional thin client device may not include a hard drive. As such, a hard drive carrier that would house the hard drive remains empty and unused. In this example, the adapter card 108 may be housed in the hard drive carrier (not shown) of the computing device 100 and the hard drive carrier may be placed over the motherboard 102. In some embodiments, adapter card 108 may be housed in an optical drive, a floppy drive, or housed in any unused region of the computing device 100.

It is appreciated that in some embodiments, the adapter card 108 may need to be modified to conform to size and height of the housing. For example, if the adapter card 108 is housed in a two and half inches (2½″) hard disk drive carrier, then the form and the printed circuit board assembly (PCBA) of the adapter card 108 may be modified to fit within the carrier.

Further, although FIG. 1 illustrates adapter card 108 positioned over motherboard 102, it is not intended to limit the embodiments herein. In some embodiments, the adapter card 108 may be positioned adjacent to the motherboard 102. In some embodiments, the adapter card 108 may be positioned adjacent or over other components within computing device 100, such as a system fan. In some embodiments, the adapter card 108 may be integrated into the motherboard 102. For example, the adapter card 108 may be integrated as a local area network on the motherboard 102 (LOM).

In some embodiments, the adapter card 108 is coupled to the motherboard interface module 104 via a channel 106. In some embodiments, the channel 106 may be a flex cable that transmits data between the adapter card 108 and the motherboard interface module 104. In some embodiments, the channel 106 may be a ribbon cable, a round cable or an electrical cable, to name a few, that can facilitate and transmit data between the adapter card 108 and the motherboard interface module 104. In some embodiments, the channel 106 may be configured to transmit data using a PCIe, PCI, PCI-X, or any protocol compatible to use with the motherboard interface module 104 and adapter card 108. In some embodiments, the adapter card 108 may be positioned, oriented, etc., vertically, horizontally, or some angle.

In some embodiments, the motherboard interface module 104 is coupled to the adapter card 108 via the channel 106 at one end 112 of module 104 and further coupled to motherboard 102 at another end 114 of module 104. In some embodiments, the ends 112 and 114 may be electrical connectors that may be coupled to the channel 106 and the motherboard 102, respectively. In some embodiments, the end 114 of motherboard interface module 104 may be indirectly connected to the motherboard 102. For example, end 114 may be connected to a local bus (not shown) to communicate with the motherboard 102.

In some embodiments, the motherboard interface module 104 may be an express miniboard or mini PCI express interface. It is appreciated that an express miniboard may be conventionally used as a wireless network adapter in computing devices. However, in this example, the express miniboard is an interface for transmitting data between the motherboard 102 and the adapter card 108. In some embodiments, the motherboard interface module 104 may be an express card or any interface module configured to facilitate data communication between the motherboard 102 and the adapter card 108.

In some embodiments, the motherboard interface module 104 may transmit data such as, processing data, clocking data to synchronize data between the motherboard 102 and adapter card 108, and data related to the features provided by the adapter card 108. In some embodiments, the motherboard interface module 104 is configured to supply power, current and/or voltage to the adapter card 108 to allow the adapter card to function and to communicate with the motherboard 102.

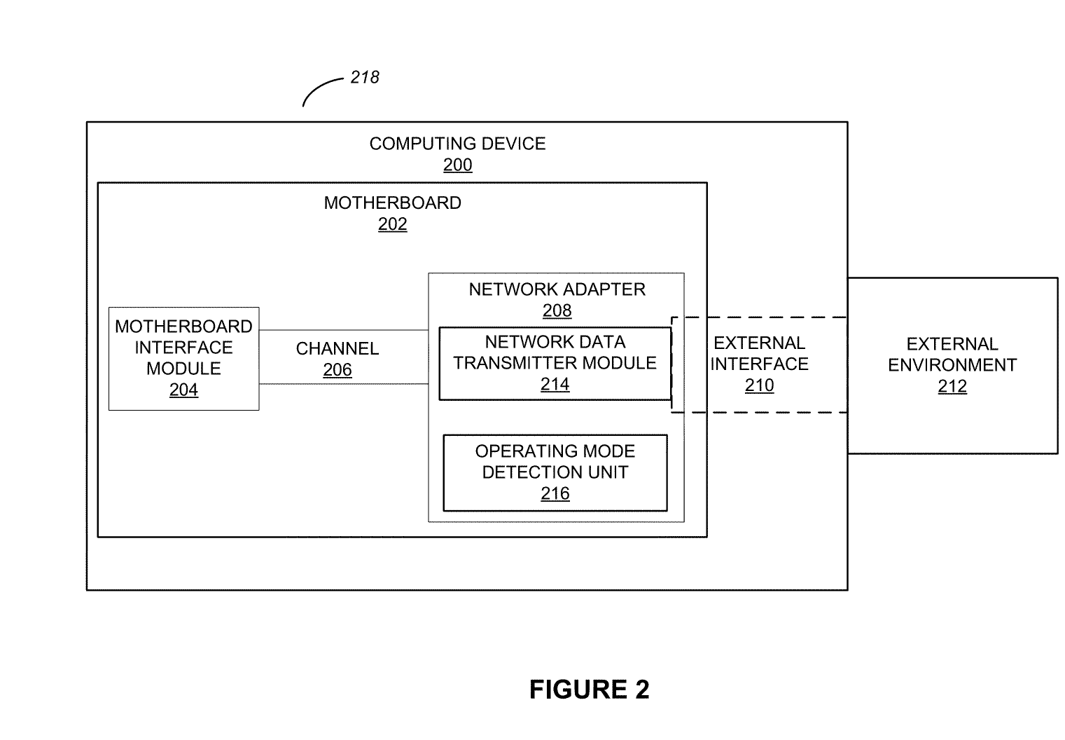

Referring now to FIG. 2, a computing device configured to house a network adapter according to some embodiments is shown. The computing device 200 includes a motherboard 202, a motherboard interface module 204, a channel 206, a network adapter 208, and an external interface 210 (depicted in dotted lines). In some embodiments, motherboard 202, motherboard interface module 204 and channel 206 may be substantially similar to the motherboard 102, the motherboard interface module 104, and channel 106 as described in FIG. 1, respectively.

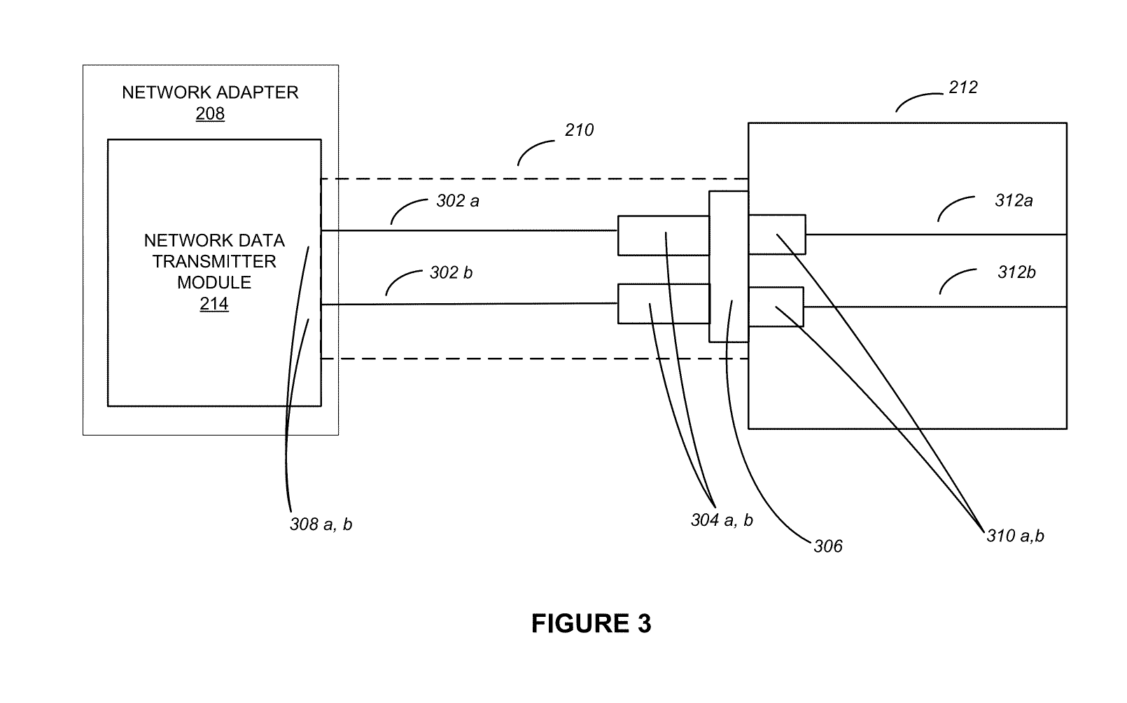

FIG. 2 illustrates incorporating the network adapter 208 in computing device 200 without using a PCI slot. In some embodiments, the network adapter 208 may be incorporated in the computing device 200 in a similar topology as described in FIG. 1 except that the network adapter is communicatively coupled to the external interface 210. The external interface 210 may be configured to couple the network adapter 208 to an external environment 212 to facilitate data communication between the network adapter 208 and the external environment 212, which is further described below in FIG. 3.

Referring back to the network adapter 208, the network adapter 208 may be a fiber optics adapter in some embodiments. In some embodiments, the network adapter 208 may be a copper wire adapter. In some embodiments, the network adapter 208 may include a network data transmitter module 214 and an operating mode detection unit 216.

In some embodiments, the network data transmitter module 214 may be configured to communicate networking data between the external environment 212 (e.g., a computer network) and the network adapter 208 by emitting light signals. In some embodiments, the network data transmitter module 214 is configured to receive electrical signals from the motherboard interface module 204 via channel 206 and convert the electrical signals into light signals. Subsequently, the light signals may be transmitted to the external environment 212.

Conventional network adapters include a built in network interface that may be used to connect to an external environment, e.g., sockets for a user to plug in a fiber optic cable. As such, when a conventional network adapter is inserted into a PCI slot, the network interface protrudes from a sidewall of the computing device to allow a user to connect, for instance, an Ethernet cable therein. However, as illustrated in FIG. 2, the network adapter 208 is not inserted into a PCI slot, and thus, a network interface is not available at a sidewall 218 to establish a direct connection to the external environment 212. Instead, in some embodiments, the network adapter 208 may be coupled to an external interface 210 (that is a non-PCI slot) configured to transmit data between the network adapter 208 and the external environment 212, as described further below in FIG. 3.

In some embodiments, the operating mode detection unit 216 is configured to determine an operating state, such as an on state or an off state of the computing device 200. Based on the operating state of the computing device 200, the operating mode detection unit 216 determines whether to perform a WoL operation.

It is appreciated that in order to provide the functionalities that are supported by PCI slots without using PCI slots, certain modifications to a network adapter may be made. In FIG. 2, to support the WoL feature, the network adapter 208 includes the operating mode detection unit 216. As noted above, the operating mode detection unit 216 determines the operating state of the computing device 200 and determines whether to perform a WoL operation.

Conventionally, a PCI slot supplies a network adapter with either 3.3 volts (V) or 0V based on an operating state of a device. For instance, if the device is an on-state, then the PCI slot supplies the network adapter with 3.3V, and 0V while the device is in an off-state. Based on the presence of a 3.3V or a 0V, the network adapter may be configured to perform a WoL operation to allow a system administrator to remotely access the device.

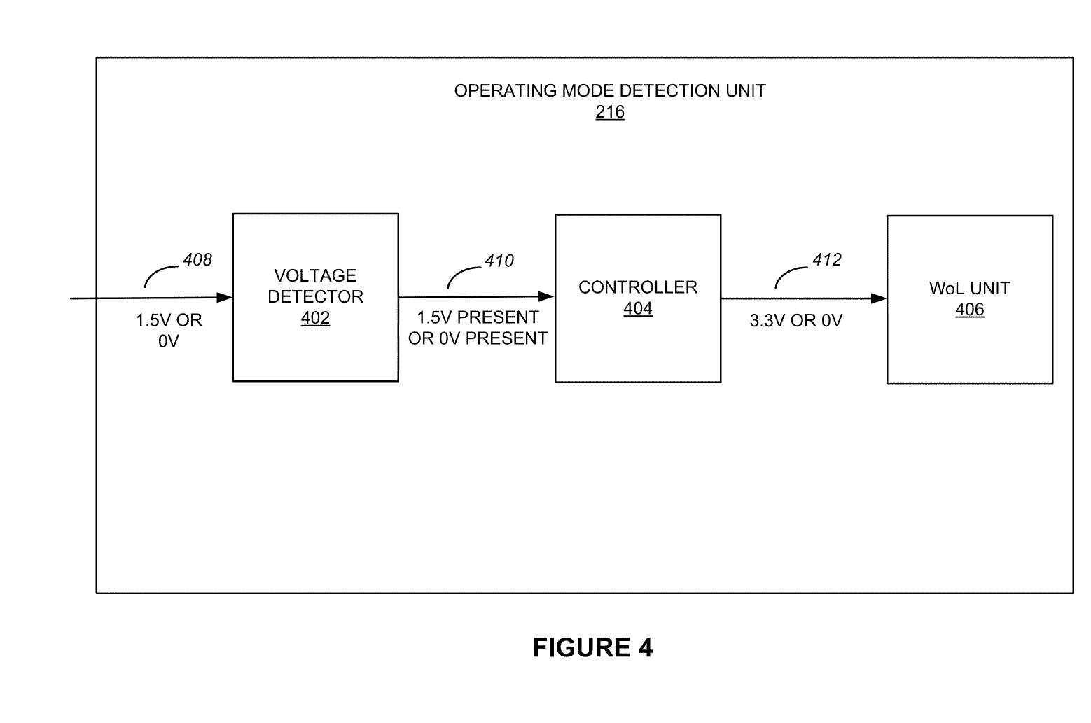

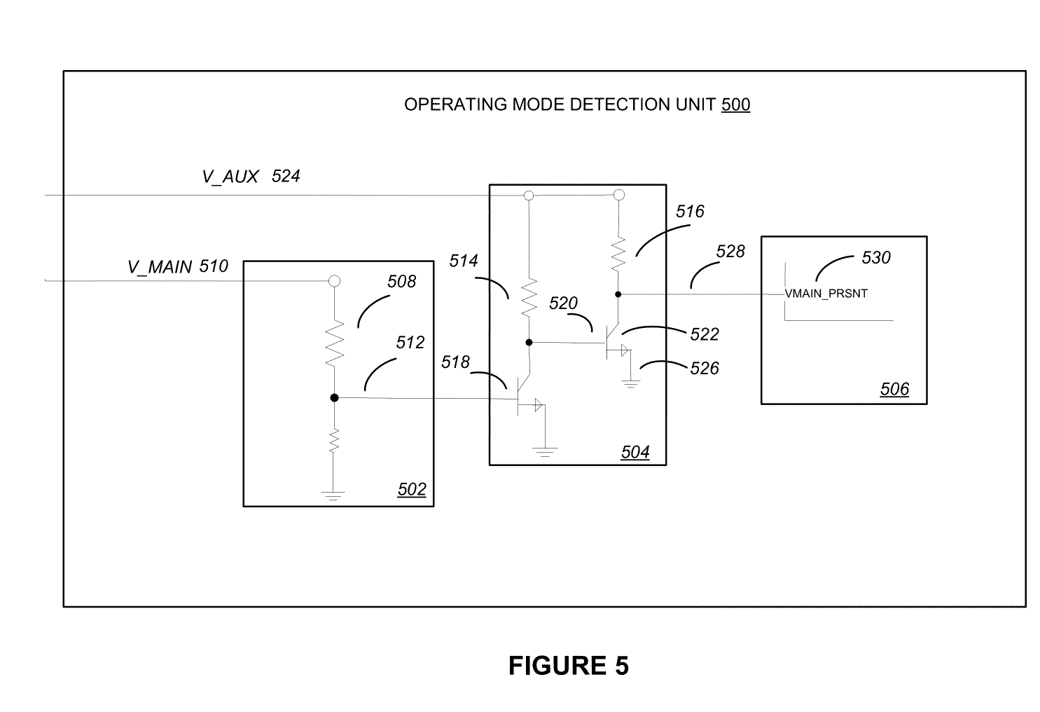

However, without inserting the network adapter 208 in a PCI slot, the network adapter 208 may not be supplied with a 3.3V or 0V to initiate a WoL operation. In some embodiments, the motherboard interface module 204 may be an express miniboard or mini PCI express interface that is configured to supply a 1.5V or 0V to the network adapter 208. As such, in this embodiment, the network adapter 208 is not supplied with the expected 3.3V or 0V to determine whether to initiate a WoL operation. To facilitate WoL features in the network adapter 208, the operating mode detection unit 216 is used to determine the operating state of computing device 200 as described further below in FIGS. 4 and 5.

Referring now to FIG. 3, an external interface according to some embodiments is shown. In some embodiments, the external interface 210 may include media cables 302a and 302b, connectors 304a and 304b, and an external socket 306. In some embodiments, the media cables 302a and 302b may be fiber optic strands, copper wire strands, Ethernet cables, or some media cables to communicate networking data between the network adapter 208 and the external environment 212 via the external socket 306. In one embodiment, media cable 302a may be configured to receive networking data, while media cable 302b may be configured to transmit networking data from the network adapter 208 to the external environment 212, or vice versa. In some embodiments, both media cables 302a and 302b may be bidirectional and configured to receive and transmit networking data. Although FIG. 3 illustrates two media cables 302a and 302b, it is appreciated that any number of media cables may be used.

In some embodiments, the media cables 302a and 302b may be coupled to the network adapter 208 at ends 308a and 308b. In some instances, ends 308a and 308b may be integrated within the network data transmitter module 214 by, for instance, soldering the media cables 308a and 308b into the network data transmitter module 214. In some instances, the ends 308a and 308b may be inserted into connectors or sockets (not shown) on the network data transmitter module 214.

In some embodiments, the media cables 302a and 302b are coupled to connectors 304a and 304b, which are coupled to the external socket 306. The external socket 306 may be configured to allow the media cables 302a and 302b to be communicatively coupled with the external environment 212. In some embodiments, external socket 306 may include sockets 304a and 304b to insert the media cables 302a and 302b therein. The external socket 306 may further include sockets 310a and 310b protruding on the outside of a wall for coupling to the external cables 312a and 312b. In some embodiments, the external cables 312a and 312b may be fiber optic cables, copper wire cables, Ethernet cables or some other cables connected to a computer network. It is appreciated that the components depicted within the external interface 210 are illustrative and not intended to limit the scope of the embodiments. For example, in some embodiments, the external interface may be a connector that is coupled to the network data transmitter module 214 at one end and includes sockets at another end to insert external cables 312a and 312b. As FIG. 3 illustrates, by using an external interface 210, a computing device can incorporate the features of the network adapter 208 without the use of a PCI slot.

Referring now to FIG. 4, an operating mode detection unit according to some embodiments is shown. The operating mode detection unit 216 may include a voltage detector 402, a controller unit 404, and a WoL unit 406. The voltage detector 402 may detect the voltage present from the motherboard. The controller unit 404 may change the detected voltage to an expected voltage value for supporting the WoL feature. For example, the WoL feature is initiated if a 0V is detected and is off if a 3.3V is detected. As such, the controller unit 404 may change the detected high voltage of 1.5V from the thin client to 3.3V and maintain the voltage at 0V if a less than 1.5V is detected, e.g., if a 0V is detected. Accordingly, the WoL unit 406 initiates a WoL functionality if it receives a 0V signal and it will not initiate the WoL functionality if it receives a signal with a 3.3V. It is appreciated that other functionalities and features may have a different voltage supplied to the adapter card from the motherboard in comparison to the PCI slot. As such, the controller unit 404 may similarly adjust the detected voltages from the motherboard in order to make them compatible with the expected voltage value of the functional units of the adapter card.

Operating mode detection unit 216 of FIG. 4 is described with reference to the computing device 200, network adapter 208 and the motherboard interface module 204 of FIG. 2. To further illustrate features of the operating mode detection unit 216, the motherboard interface module 204 is described as an express miniboard as described herein. It is appreciated that the disclosure of the operating mode detection unit 216 with reference to the computing device 200, the network adapter 208 and an express miniboard is illustrative and is not intended to limit the scope of the embodiments.

As noted above, the network adapter 208 includes the operating mode detection unit 216 to facilitate the WoL feature for the network adapter 208 by supplying the expected voltages 3.3V or 0V to initiate the WoL operation. In some embodiments, the operating mode detection unit may be configured to determine the amount of voltage supplied by a motherboard interface, change the voltage to an expected voltage, determine the operating state of the computing device, and initiate a WoL operation accordingly.

In some embodiments, the voltage detector 402, the controller unit 404 and the WoL unit 406 may be a combination of field effect transistors (FET), bipolar transistors, capacitors, inductors, and/or resistors to determine the operating state of computing device 200 of FIG. 2. In some embodiments, the voltage detector 402, the controller unit 404 and the WoL unit 406 may be a combination of circuitry and programming logic such as a programmable field gate arrays.

In some embodiments, the voltage detector 402 is configured to determine whether a specific voltage or voltages are present at motherboard interface. In some embodiments, voltage detector 402 may receive a voltage from the express miniboard or mini PCI express interface that connects the motherboard 202 and the network adapter 208. In this example, the express miniboard supplies a voltage 408 of 1.5V when the computing device is in an on state, and 0V when the computing device is in an off state.

According to one embodiment, the detected voltage is communicated to the controller unit 404. In some embodiments, the voltage detector 402 may transmit a signal to controller unit 404 to indicate the presence of either the 1.5V or the 0V. For example, if the voltage detector 402 determines that 1.5V is received from the express miniboard or mini PCI express interface, the voltage detector 402 sends a signal 410 having a certain value, e.g., one, to controller unit 404 indicating that 1.5V is present. Otherwise, if 0V is received, then the voltage detector 402 sends a signal 410 having another value, e.g., zero, indicating that 0V is present. In one embodiment, the transmitted signal 410 may be the detected voltage, e.g., 1.5V or 0V.

In some embodiments, the controller unit 404 is configured to change the voltage 408 received from the express miniboard or mini PCI express interface based on the signal 410 received from the voltage detector 402. In some embodiments, if the controller unit 404 receives 1.5V from the voltage detector 402, then the controller unit 404 changes the voltage from 1.5V to 3.3V and supplies the 3.3V to the WoL unit 406 via connection 412. On the other hand, if the controller unit 404 receives 0V from the voltage detector 402, then the controller unit 404 may maintain the voltage at 0V and supply the 0V to the WoL unit 406.

In some embodiments, the controller unit 404 may include switches, resistors, transistors and amplifiers to change the voltage 408 based on the determination of voltage detector 402. In some embodiments, the controller unit 404 may include programming logic that determines and changes the voltage 408 to a predetermined voltage as described herein. In one embodiment, a buck circuitry may be used to implement the controller unit 404.

In some embodiments, the WoL unit 406 may be a network controller, similar to a network controller provided by Allied Telesis®. According to one embodiment, the WoL unit 406 facilitates WoL functionality.

In some embodiments, the WoL unit 406 is configured to determine whether a computing device is in an on state or in an off state in response to the received voltage 412 from the controller unit 404. For example, if 3.3V is received, then the WoL unit 406 may determine that the computing device is in an on state. In some embodiments, if it is determined that the computing device is in an on state, then the WoL unit 406 may not initiate a WoL operation.

On the other hand, if 0V is received, then the WoL unit 406 determines that the computing system is in an off state. In some embodiments, if it is determined that the computing device is in an off-state, then the WoL unit 406 initiates a WoL operation. For example, the WoL unit 406 may allow a remote computing device to send packets to the computing device to change the computing device from an off state to a WoL state, thereby allowing the computing device 200 to be accessed remotely.

It is appreciated that the specific numbers provided are examples and for illustration purposes only and are not intended to limit the scope of the embodiment. For example, embodiments described herein, cover functionalities and features that use voltages different from 0V, 1.5V, and 3.3V. For example, a feature of an adapter card supported by a PCI slot may use 1V and 2V. In this example, the express miniboard or mini PCI express interface may supply 0V and 0.5V to the adapter card from the motherboard. As such, the detected voltages from the motherboard may similarly be adjusted to 1V and 2V respectively to support the feature of the adapter card. Further, it is appreciated that the embodiments cover ranges of voltages.

Referring now to FIG. 5, an operating mode detection unit according to some embodiments is shown. In some embodiments, the operating mode detection unit 500 may function in a substantially similar manner as operating mode detection unit 216 as described in FIGS. 2 and 4. In some embodiments, the operating mode detection unit 500 includes circuits 502, 504, and 506. It is appreciated that the circuits described in FIG. 5 are illustrative and are not intended to limit the embodiments. For instance, circuits 502, 504, and 506 may be a combination of field effect transistors (FET), bipolar transistors, capacitors, inductors, and/or resistors that may be used to initiate a WoL operation in an adapter card.

In some embodiments, circuit 502 may function in a substantially similar manner as the voltage detector 402 of FIG. 4. In this example, circuit 502 includes a resistor 508 that is coupled to a main voltage over a V_MAIN bus 510. In some embodiments, the circuit 502 receives the main voltage from a motherboard interface module, such as an express miniboard or mini PCI express interface of a computing device as described herein. For example, the motherboard interface may supply 1.5V to circuit 502 via the V_MAIN bus 510 when the computing device is an on state, thereby applying a non-zero voltage at gate 512. When the computing device is in an off-state, the motherboard interface may supply 0V, thereby applying 0V to across gate 512.

In some embodiments, circuit 504 may function in a substantially similar manner as controller unit 404 of FIG. 4. Circuit 504 includes resistors 514 and 516, and transistors 518 and 522. In some embodiments, the gate 512 of the transistor 518 is coupled to circuit 502. In some embodiments, the gate 520 of the transistor 522 is coupled to the collector of transistor 518 while its collector is coupled to a V_AUX bus 524 via the resistor 516 and its emitter is coupled to ground 526.

In some embodiments, the switch 518 closes if a voltage, e.g., 1.5V, is present at the gate 512 of the transistor 518. Otherwise, the switch 518 may open if a 0V is detected at the gate 512. The switch 522 opens if the switch 518 is closed and the switch 522 closes if the switch 518 opens. Accordingly, when the switch 518 opens and the switch 522 closes, the voltage from V_AUX bus 524 will be across connection 528. On the other hand, when the switch 518 closes and the switch 522 opens, the voltage across the connection 528 will be 0V. In other words, when the system is in off mode the voltage across 528 is 0V and when the system is in on mode the voltage across 528 is 3.3V as expected when a PCI slot is used even though here no PCI slot is used. Accordingly, the circuit 506 facilitates WoL features as if a PCI slot was used. Circuit 506 functions substantially similar to the WoL unit 406. In some embodiments, circuit 506 may include a VMAIN_PRSNT pin 530 that is configured to determine whether a specific voltage or voltages are present. For example, if a predetermined voltage, such as 3.3V, is present at VMAIN_PRSNT pin 530, then it is determined that a computing device is an on state and a WoL operation may not be initiated (circuitry not shown). On the other hand, if 0V is present at VMAIN_PRSNT pin 530, then it is determined that the computing device is in an off state and a WoL operation may be initiated.

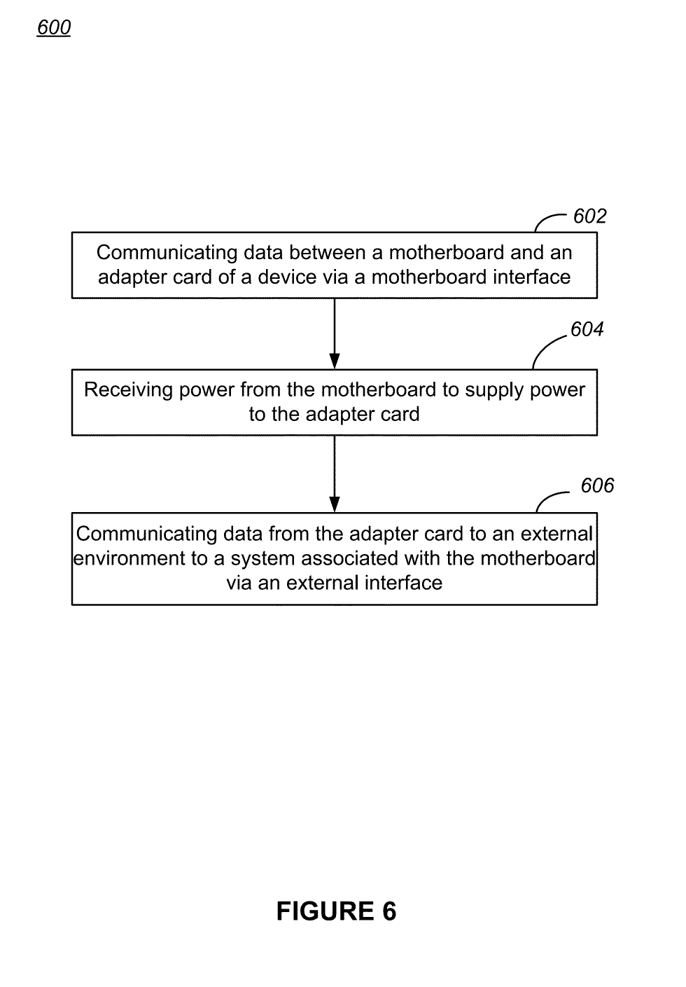

Referring now to FIG. 6, an illustrative flow diagram for data communication of an adapter card according to some embodiments is shown. At step 602, data between a motherboard and an adapter card of a device is communicated via a motherboard interface. In some embodiments, the motherboard may be similar to the motherboards 102 and 202 of FIGS. 1 and 2, respectively. In some embodiments, the adapter card may be similar to the adapter card 108 of FIG. 1 and the network adapter 208 of FIG. 2. In some embodiments, the adapter card may be a fiber optics adapter, a graphics card, a network adapter, a sound card, or any peripheral component that is conventionally inserted into a PCI slot. In some embodiments, the adapter card may be a component of a thin client computing device.

The motherboard interface may be similar to the motherboard interface modules 104 and 204 of FIGS. 1 and 2, respectively, in some embodiments. In some instances, the motherboard interface may be an express miniboard or mini PCI express interface. The motherboard interface may communicate data using a PCIe, PCI, PCI-X, or any protocol compatible with the motherboard interface and the adapter card. In some embodiments, the data communicated between the motherboard and the adapter card may be processing data, clocking data and other data to utilize features of the adapter card.

At step 604, power is received from the motherboard to power the adapter card. In some embodiments, the power is received by a motherboard interface, such as the motherboard interface module 104 and 204 of FIGS. 1 and 2, and it supplies the power to an adapter card. In some embodiments, the motherboard interface receives the power from the motherboard and transmits the power over a connection, such as channels 106 and 206 of FIGS. 1 and 2, to the adapter card.

In some embodiments, the motherboard interface module may receive and transmit a voltage to the adapter card to use certain features of the adapter card. For example, the motherboard interface module may transmit certain voltages to an operating mode detection unit of an adapter card, such as the operating mode detection unit described in FIGS. 2, 4 and 5, to initiate a WoL operation.

At step 606, data from the adapter card is communicated to an external environment to a system associated with the motherboard via an external interface. In some embodiments, the adapter card may communicate networking data to an external environment, such as a computer network. In some embodiments, the adapter card may comprise a fiber optics module that communicates networking data to the external environment by emitting light signals.

In some embodiments, the adapter card communicates data via the external interface. In some embodiments, the external interface is a non-PCI slot configured to communicate data between the adapter card and the external environment. In some embodiments, the external interface is substantially similar to the external interface 210 of FIGS. 2-3.

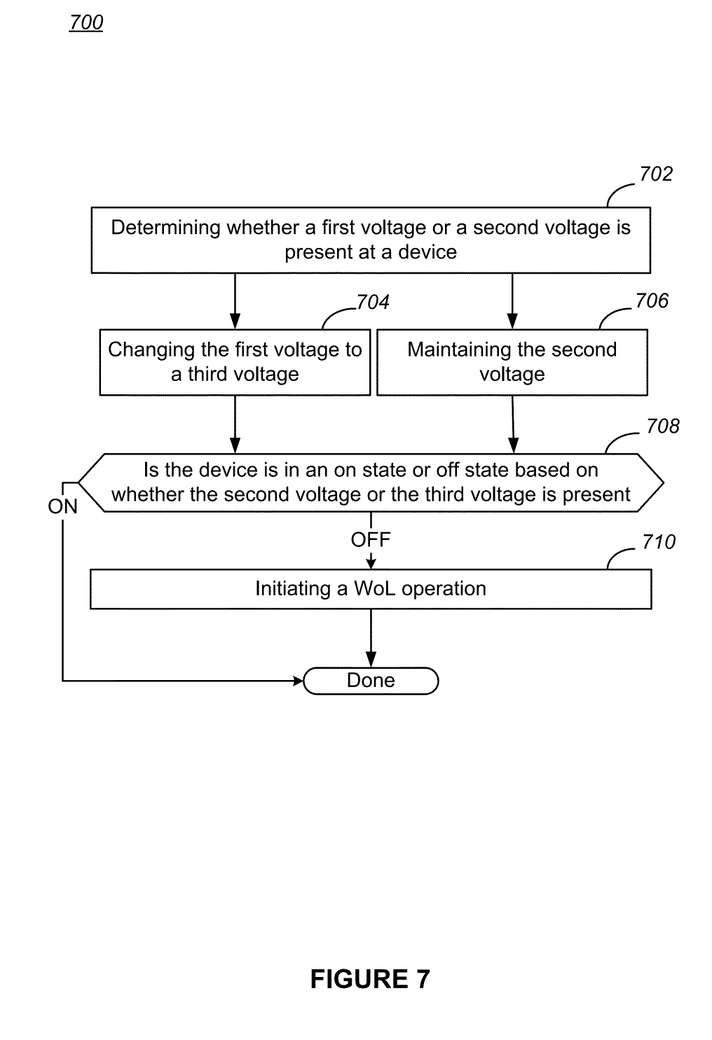

Referring now to FIG. 7, an illustrative flow diagram to determine an operational state of a computing device to initiate a wake on local access network (WoL) operation according to some embodiments is shown. In some embodiments, parts or all of method 700 may be performed by an operating mode detection unit of an adapter card as described in FIG. 2 and FIGS. 4-5.

At step 702, it is determined whether a first voltage or a second voltage is present at a device. In some embodiments, a voltage detector of a operating mode detection unit, such as the voltage detector described in FIGS. 4-5, may determine whether a first voltage or a second voltage is present at a motherboard interface. For example, if the motherboard interface is an express miniboard or mini PCI express interface, then the voltage detector may determine whether a 1.5V or a 0V is present at the express miniboard. In some embodiments, if it determined that a first voltage (e.g., 1.5V) is present, then method 700 proceeds to step 704. Otherwise, if it is determined that a second voltage (e.g., 0V) is present, then method 700 proceeds to step 706.

At step 704, the first voltage is changed to a third voltage in response to a determination at step 702 that the first voltage is present. In some embodiments, a controller unit, such as the controller unit described in FIGS. 4-5, may change the first voltage to a third voltage. For example, if it is determined that 1.5V is present at a motherboard interface, then the controller unit may change the 1.5V to a predetermined voltage, such as 3.3V, to utilize a WoL feature of an adapter card.

At step 706, a second voltage is maintained in response to a determination at step 702 that the second voltage is present. For example, if it is determined that 0V is present at motherboard interface, then the controller unit may maintain the 0V to determine the operating state of a device. In another example, the controller unit may change the 0V to a predetermined voltage that falls within a certain range, such as a voltage less than or equal to 0.8V. In some embodiments, the second voltage may be changed to a fourth voltage in a substantially similar manner as described in FIGS. 4-5.

At step 708, it is determined whether the device is in an on state or an off state based on whether the second voltage or a third voltage is present or alternatively based on the value of the first voltage and the second voltage. In some embodiments, a WoL unit, such as the WoL units of FIGS. 4-5, may determine whether the device is in an on state or an off state. For instance, if it is determined that a third voltage (e.g., 3.3V) is present, then it may be determined that the device is in an on state. If it is determined that the device is in an on state, then it may be determined that a WoL operation does not need to be initiated and method 700 may end.

In some embodiments, if it is determined that second voltage (e.g., 0V) is present, then it may be determined that the device is in an off state. Then, method 700 proceeds to step 710 to initiate a WoL operation. At step 710, the WoL operation may be initiated by changing the device from an off state to a WoL state to receive networking data packets to allow remote access of the device.

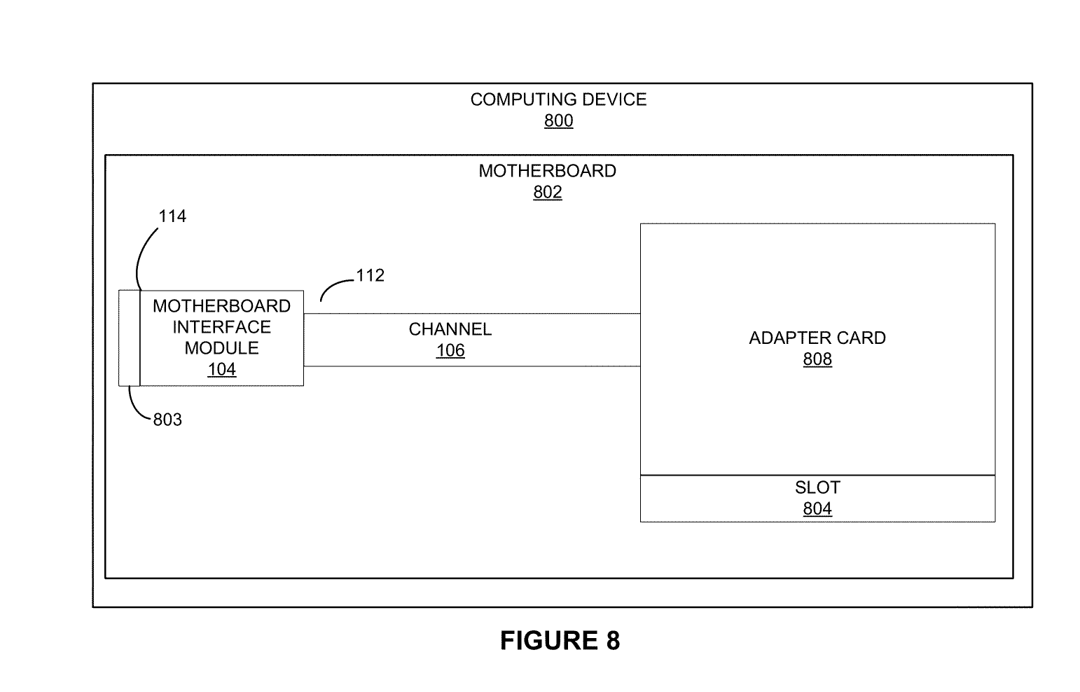

FIG. 8 shows a computing device configured to house an adapter card in accordance with some embodiments. The computing device 800 of FIG. 8 includes motherboard 802, adapter card 808, channel 106, motherboard interface module 104, and slot 803. In some embodiments, the computing device 800 may be substantially similar to the computing device 100. In some embodiments, the motherboard 802 is substantially similar to the motherboard 102. In some embodiments, the adapter card 808 is substantially similar to the adapter card 108. In some embodiments, the channel 106 is a flex cable configured for connecting the adapter card 808 to motherboard interface module 104 which may couple the adapter card 808 to the slot 803 of the motherboard 802. In some embodiments, the slot 803 may be a mini PCI express interface. In some embodiments, the motherboard interface module 104 is configured for coupling to a PCI express mini or mini PCI express slot. In some embodiments, the mini PCI express slot is not being used (e.g., with a wireless card, storage card, etc.).

In some embodiments, computing device 800 may be a thin client device with reduced number of PCI slots, e.g., fewer than two PCI slots. Although many of the features are illustrated with reference to PCI slots, it is appreciated that the discussion of PCI slots is illustrative and is not intended to limit the scope of the embodiments. For example, in some embodiments, the features described herein may be applicable to thin clients with reduced number of PCIe slots, PCI-X slots, or any other expansion slots. The adapter cards according to some embodiments may use appropriate protocols of the corresponding slot, e.g., PCI slots, PCI-X slots, PCIe slots, or any other expansion slots, to enable the adapter card to function as if it was inserted into the PCI slot even though it is not.

The motherboard 802 includes slot 804. Slot 804 may be any of a variety of expansion slots. In some embodiments, slot 804 is a Mobile PCI Express Module (MXM) slot. Slot 804 may be configured for communicatively coupling of an MXM graphics component for enhancing the graphics capabilities of the computing device 800.

In some embodiments, the adapter card 808 is configured to be anchored, structurally supported, etc., by slot 804. In some embodiments, the adapter card 808 is configured for coupling to slot 804, where slot 804 is an MXM slot. In some embodiments, the adapter card 808 is sized according to a standard MXM form factor, footprint, etc., (e.g., MXM-I, MXM-II, MXM-III (HE), MXM-IV, MXM-A, MXM-B, etc.).

In some embodiments, the adapter card 808 is anchored onto the standard standoffs for the slot 804. In some embodiments, the adapter card 808 is designed, configured, etc., for having electrical traces based on a MXM form factor while not being electrically couplable to a MXM slot. In some embodiments, the adapter card 808 is not electrically coupled to the slot 804. In some embodiments, the MXM slot 804 functions as an anchor point, physical support, mechanical support, structural support, etc., for the adapter card 808. Some embodiments thereby allow the addition of component functionality (e.g., communications device functionality, storage functionality, etc.) when a hard disk drive slot is occupied, not available, etc.

In some embodiments, the adapter card 808 is not electrically coupled to the MXM slot. In some embodiments, the adapter card 808 includes a portion, edge, etc., (not shown), as described below, having connectors (e.g., non-conductive, non-metal, etc.) that are configured for coupling to slot 804 without communicatively coupling to slot 804. For example, adapter card 808 may have a plastic edge that is configured for coupling with an MXM slot. Slot 804 may thus be used as a physical location for securing of the adapter card 808 within computing device 800.

In some embodiments, the adapter card 808 is a peripheral component configured to be positioned in a non-peripheral connect interface (PCI) slot location. The peripheral component may facilitate communication between a system (e.g., including the motherboard 802) and an external environment (e.g., via Ethernet, fiber optics, etc.). The system comprises a motherboard (e.g., including the motherboard 802) associated with the device (e.g., the computing device 800). In some embodiments, the external environment is an environment external to the system or computing device 800.

The system may include a first motherboard interface (e.g., the slot 803) configured to couple the peripheral component (e.g., the adapter card 808) to the motherboard (e.g., the motherboard 802). In some embodiments, the first motherboard interface comprises a mini PCI express interface. The first motherboard interface is configured to communicate data between the peripheral component and the motherboard. The first motherboard interface may be further configured to supply power to the peripheral component. The system may further comprise a second motherboard interface (e.g., the slot 804) configured to physically couple the peripheral component to the motherboard. In some embodiments, the second motherboard interface comprises a Mobile PCI Express Module (MXM) interface. In some embodiments, the peripheral component is configured to be non-electrically coupled via the second motherboard interface.

In some embodiments, an area for a storage drive (e.g., a hard disk drive slot, a solid state drive slot, etc.) may not be available because a storage or other device may be located in the storage area while a slot, an area, etc., for another component may be available. Embodiments are thus configured for using a PCI express mini slot while a hard drive slot is occupied. For example, the computing device 800 may not have any PCI express slots or connectors which allow connection of a fiber adaptor that would provide fiber connectivity. As another example, a small computing device may not have any slots that allow insertion of full size or low profile expansion cards.

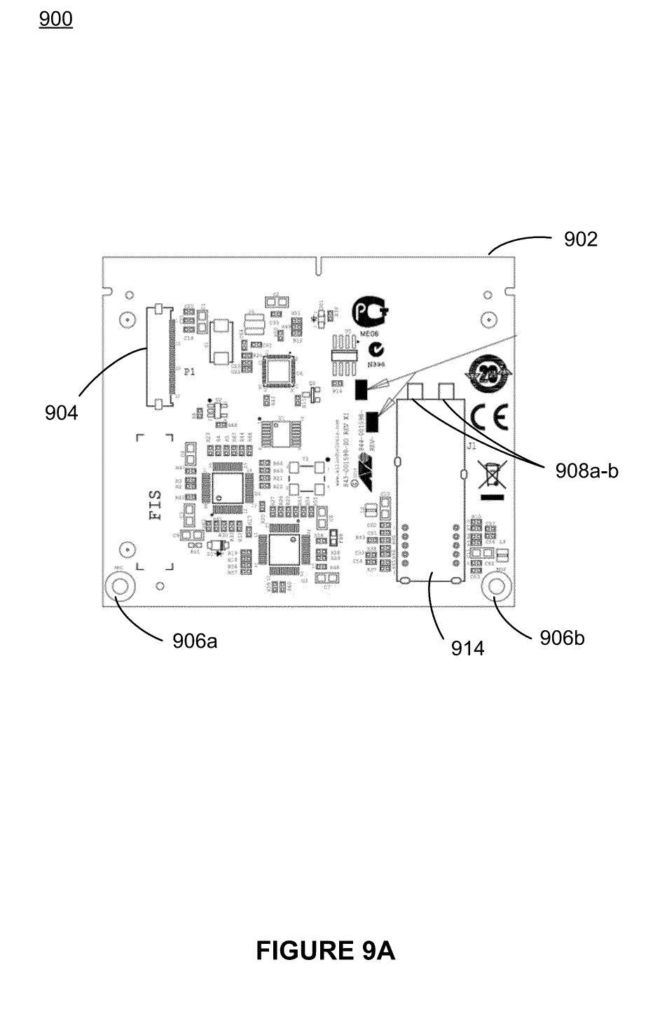

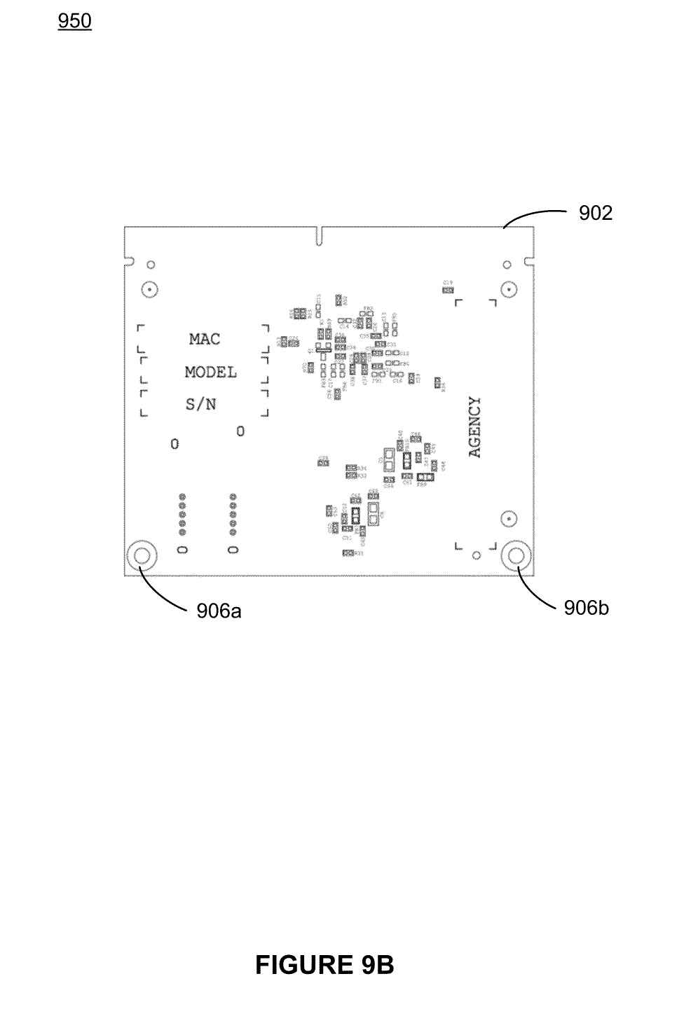

FIGS. 9A-B show a network adapter in accordance with some embodiments. FIG. 9A show a primary or top view of an adapter card 900. In some embodiments, the adapter card 900 is substantially similar to the adapter card 808. In some embodiments, the adapter card 900 is sized according to a standard MXM form factor, footprint, etc., (e.g., MXM-I, MXM-II, MXM-III (HE), MXM-IV, MXM-A, MXM-B. etc.).

The adapter card 900 includes a coupling edge 902, a channel interface 904, a network data transmitter module 914, ends 908a-b, and mounting areas 906a-b. FIG. 9B shows a second or bottom view of an adapter card 900. When viewed from the bottom, the adapter 900 includes mounting areas 906a-b and coupling edge 902.

The coupling edge 902 is configured for anchoring, structurally supporting, etc., the adapter card 900 within a slot (e.g., the slot 804). In some embodiments, the coupling edge 902 is configured for coupling to the slot 804, where the slot 804 is an MXM slot. The channel interface 904 is configured for coupling of a communication apparatus (e.g., the channel 106, the channel 206, etc.). In some embodiments, the channel interface 904 is configured for coupling of a channel for coupling the adapter card 900 to a motherboard (e.g., via the motherboard interface module 104, the motherboard interface module 204, etc.).

The network data transmitter module 914 is configured for facilitating communication between adapter card 900 and an external environment (e.g., LAN, the Internet, etc.). In some embodiments, the network data transmitter module 914 is substantially similar to the network data transmitter module 214.

The ends 908a-b are configured for coupling of one or more communications apparatuses. For example, the ends 908a-b may be configured for coupling of fiber optic cables for interfacing with an external socket (e.g., the external socket 306). In some embodiments, the ends 908a-b are substantially similar to the ends 308a-b.

The mounting areas 906a-b are configured for physically coupling, mounting, etc., the adapter card 900 to a slot (e.g., the slot 804). In some embodiments, the mounting areas 906a-b includes holes configured for coupling to, interfacing with, etc., standoffs of a motherboard. For example, the standoffs of a motherboard may be configured for structurally supporting an MXM adapter card.

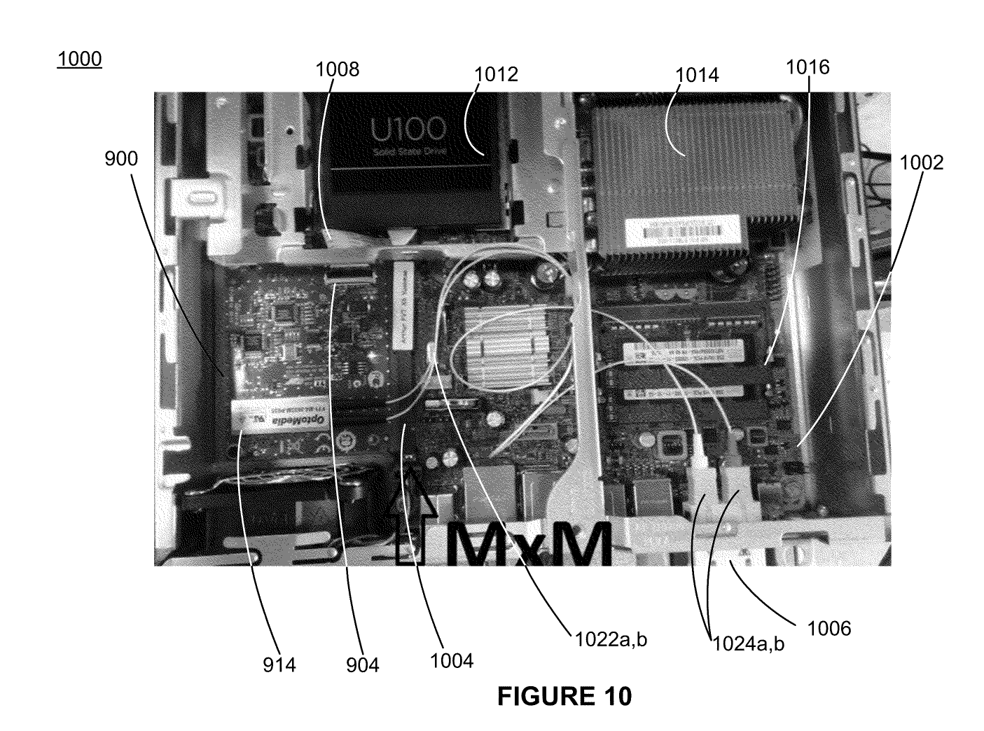

FIG. 10 shows a computing device and a network adapter in accordance with some embodiments. FIG. 10 depicts an adapter card 900 mounted in a computing device 1000. The computing device 1000 includes the adapter card 900, a motherboard 1002, an external socket 1006, a storage device 1012, a heatsink and processor 1014, memory 1016, and connectors 1024a-b. In some embodiments, the adapter card 900 is positioned in a non-PCI slot location.

The motherboard 1002 includes a slot 1004. In some embodiments, the slot 1004 is substantially similar to slot 804. The adapter card 900 is coupled (e.g., physically, structurally, etc.) to the slot 1004 of the motherboard 1002. In some embodiments, the adapter card 900 is not electrically coupled to the slot 1004 of the motherboard 1002.

The slot 1004 may be a motherboard interface configured for communicative coupling of a component, e.g., a MXM graphics card. In some embodiments, the adapter card 900 comprises a portion configured for structurally coupling of the adapter card 900 to the motherboard interface 1004. In some embodiments, the portion of the adapter card 900 is configured to non-electrically couple the adapter card 900 to the motherboard interface. In some embodiments, the motherboard interface comprises a Mobile PCI Express Module (MXM) interface.

The motherboard 1002 is coupled to the storage device 1012, the heatsink and processor 1014, and the external socket 1016. The storage device 1012 may be any of a variety of storage devices (e.g., solid state drive, hard disk drive, etc.), as described herein. The heatsink and processor 1014 includes a heatsink or other thermal dissipating device for cooling a processor and a processor configured for performing computations, as described herein. The external socket 1006 is configured for coupling of communication channels within the computing device 1000 to communications channels outside of computing device 1000. The memory 1016 may be any of a variety of memory devices (e.g., double data rate (DDR) random access memory, solid state drive (SSD), hard disk drive (HDD), etc.), as described herein.

The channel 1008 communicatively and electrically couples the adapter card 900 to the motherboard 1002. In some embodiments, the adapter card 900 is coupled to the motherboard 1002 via the channel 1008 and a motherboard interface module (not shown) (e.g., the motherboard interface module 104, the motherboard interface module 204, etc.) configured for coupling the adapter card to a motherboard 1002. The motherboard interface is configured to transmit data between the adapter card 900 and the motherboard 1002. The motherboard interface is configured to supply power from the motherboard 1002 to the adapter card 900. In some embodiments, the motherboard interface module may be a mini PCI express card configured to be coupled to a mini PCI express slot (not shown) of the motherboard 1002. In some embodiments, the channel 1008 is substantially similar to the channel 106, the channel 206, etc.

In some embodiment, the adapter card 900 includes an external interface 914 for coupling the adapter card 900 to an external environment of a system 1000 associated with the motherboard 1002. The external interface is configured to transmit data between the external environment of the system 1000 and the adapter card 900. In some embodiments, the adapter card 900 comprises a fiber optic module. In some embodiments, the interface 914 is a network data transmitter module configured to communicate networking data between the external environment of the system and the adapter card 900 via emitting light signals.

The media cables 1022a-b couple the adapter card 900 to external socket 1006 thereby allowing the adapter card 900 to communicate externally to computing device 1000. In some embodiments, the media cables 1022a-b are coupled to external socket 1006 via connectors 1024a-b. The external socket 1006 may be configured to allow the media cables 1022a and 1022b to be communicatively coupled with an external environment (e.g., the external environment 212). In some embodiments, the connectors 1024a-b may be substantially similar to connectors 304a-b. External socket 1006 may be coupled to a case or chassis of the computing device.

In some embodiments, the adapter card 900 comprises an operating mode detection unit configured to determine an operating state of the motherboard 1002, as described herein. In some embodiments, the adapter card 900 is configured to determine whether to perform a wake on local access network (WoL) operation, as described herein. In some embodiments, the adapter card 900 is configured to determine whether the motherboard 1002 is in an on state or an off state, as described herein. The adapter card 900 may be further configured to initiate the wake on local access network (WoL) operation in response to determining that the motherboard 1002 is in the off state, as described herein.

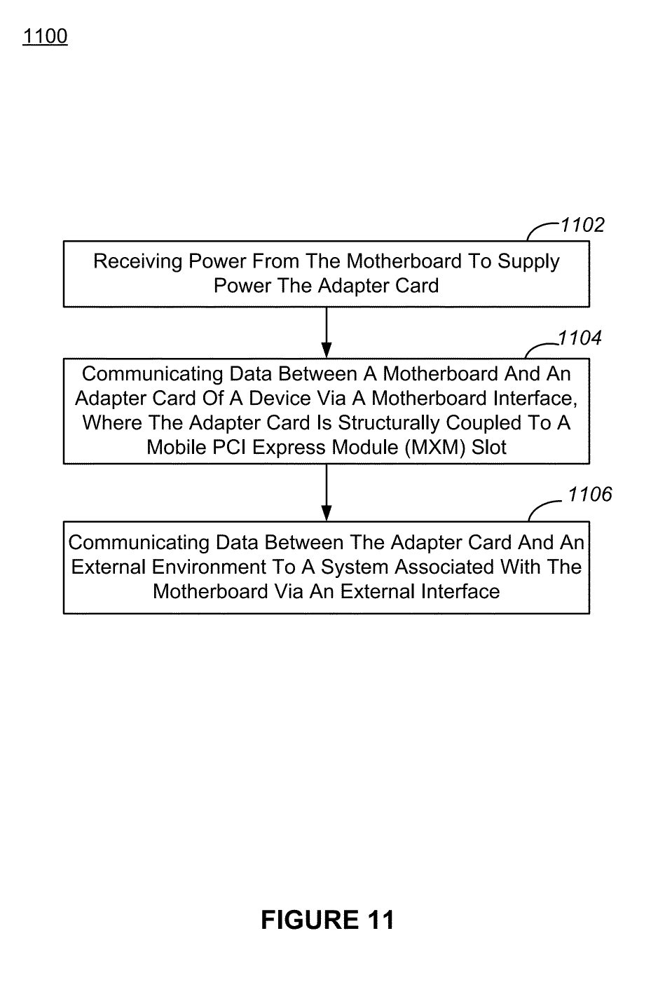

FIG. 11 shows an illustrative flow diagram for data communication of an adapter card in accordance with some embodiments. FIG. 11 depicts a process 1100 for communication via an adapter card (e.g., the adapter card 800, the adapter card 1200, the adapter card 108, the adapter card 208, etc.).

At block 1102, power from the motherboard to supply power the adapter card is received via a motherboard interface. In some embodiments, the motherboard interface comprises a Mini PCI express interface. In some embodiments, the adapter card is non-electrically coupled to a Mobile PCI Express Module (MXM) slot of the motherboard.

At block 1104, data is communicated between a motherboard and an adapter card of a device via the motherboard interface, where the adapter card is structurally coupled with a Mobile PCI Express Module (MXM) slot of the motherboard. In some embodiments, the adapter card is communicatively coupled to the motherboard by the motherboard interface.

At block 1106, data is communicated between the adapter card and an external environment to a system associated with the motherboard via an external interface. In some embodiments, the communication includes emitting light signals to communicate networking data between the adapter card and the external environment.

In some embodiments, the process 1100 further includes determining an operating state associated with the motherboard and determining whether to perform a wake on local access network (WoL) operation based on the operating state. In some embodiments, the motherboard interface comprises an express miniboard.

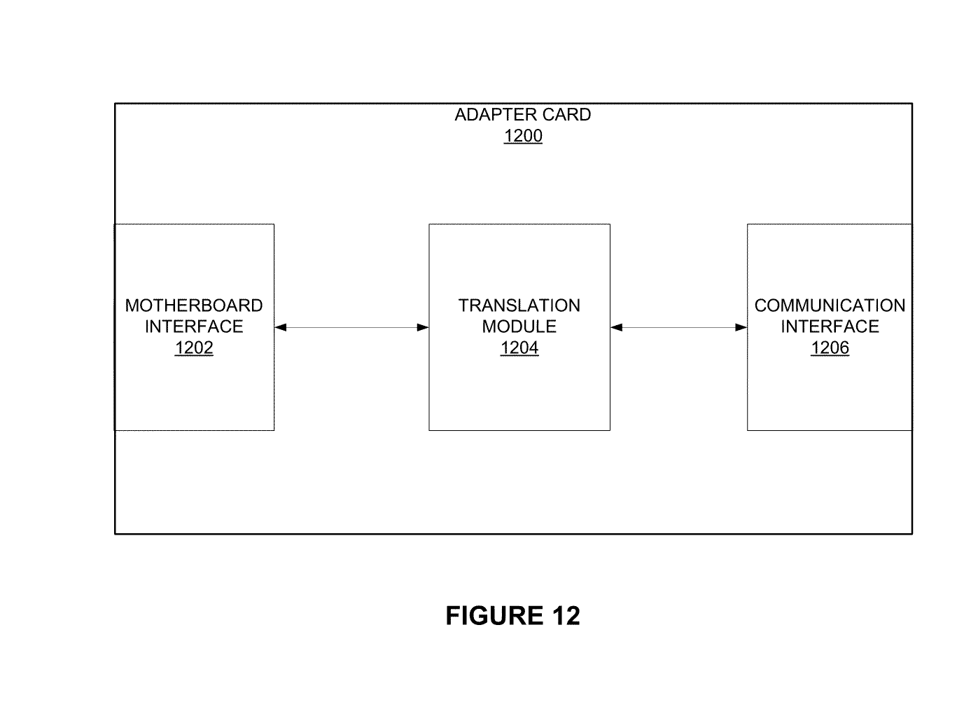

FIG. 12 shows an illustrative adapter card in accordance with some embodiments. FIG. 12 depicts an adapter card 1200, which is configured for coupling to a motherboard. In some embodiments, the adapter card 1200 is configured for coupling to a mini PCI Express slot or port of a motherboard. In some embodiments, the adapter card 1200 is an express mini board with connectors for fiber optic cables. In some embodiments, the adapter card 1200 is substantially similar to the adapter card 108 including mini PCI Express functionality and electrical support for WoL. In some embodiments, the adapter card 1200 has substantially a mini PCI express card form factor. In some embodiments, a portion of the adapter card 1200 extends beyond a standard mini PCI express card form factor.

Embodiments allow the use of an otherwise unused motherboard slot for communication with an external environment. For example, embodiments allow use of a motherboard interface operable for a wireless card to be used for wired (e.g., electrical, optical, etc.) communication. As another example, embodiments may allow use of a mini PCI express slot for fiber optic communications. Further, some embodiments are substantially located on a single board (e.g., printed circuit board, express miniboard, etc.) thereby having reduced points of failure.

In some embodiments, the adapter card 1200 may be larger in one or more dimensions of a standard mini PCI express card or express miniboard. In some embodiments, the adapter card 1200 is substantially of a mini PCI express form factor. In some embodiments, the motherboard interface 1202 includes one or more electrical circuits for PCI express interfacing. In some embodiments, the one or more electrical circuits may be configured for translating mini PCI express signals to PCI express signals.

The adapter card 1200 includes a motherboard interface 1202, a translation module 1204, and a communication interface 1206. The motherboard interface 1202 is configured for coupling adapter card 1200 to a motherboard (e.g., the motherboard 102, the motherboard 202, etc.). In some embodiments, the motherboard interface 1202 is configured for communicatively coupling adapter card 1200 to a motherboard (e.g., the motherboard 102, the motherboard 202, etc.). In some embodiments, the motherboard interface 1202 is configured to transmit data between the adapter card 1200 and a motherboard (e.g., the motherboard 102, the motherboard 202, and the motherboard 802). In some embodiments, the motherboard interface 1202 is configured to supply power from the motherboard (e.g., the motherboard 102, the motherboard 202, and the motherboard 802) to the adapter card 1200. In some embodiments, the motherboard interface 1202 is a mini PCI express interface.

The translation module 1204 is configured for translating, bridging, etc., communications between the motherboard interface 1202 and the communication interface 1206. In some embodiments, the translation module 1204 includes components for translating electrical signals, optical signals, and data signals between the motherboard interface 1202 and the communication interface 1204. For example, the translation module 1204 may translate mini PCI express electrical and data signals to a format suitable for transmission via a fiber optic transceiver. As another example, the translation module 104 may translate PCI express electrical and data signals, received from motherboard interface 1202, to a format suitable for transmission via a fiber optic transceiver. In some embodiments, the translation module 1204 includes functionality that is substantially similar to operating mode detection unit 216. In some embodiments, the translation module 1204 includes an Ethernet controller, electrical/optical adapter, and optical/electrical adapter.

In some embodiments, the translation module 1204 includes an operating mode detection unit configured to determine an operating state of the motherboard, as described herein. In some embodiments, the translation module 1204 is configured to determine whether to perform a wake on local access network (WoL) operation, as described herein. In some embodiments, the translation module 1204 is configured to determine whether the motherboard is in an on state or an off state, as described herein. The adapter card may be further configured to initiate the wake on local access network (WoL) operation in response to determining that the motherboard is in the off state, as described herein.

The communication interface 1206 is configured for facilitating communication of adapter card 1200 with an external environment. In some embodiments, the communication interface 1206 includes a network data transmitter module configured to communicate networking data between the external environment of the system and the adapter card 1200 via emitting light signals. In some embodiments, the communication interface 1206 includes a fiber optic transmitter, receiver, transceiver, etc., for facilitating fiber optic communication. In some embodiments, the optical transmitter is a portion of an optical transceiver of the adapter card 1200. In some embodiment, the communication interface 1206 is substantially similar to the network data transmitter module 214. In some embodiments, the communication interface 1206 is an external interface for coupling the adapter card 1200 to an external environment of a system associated with the motherboard. In some embodiments, the external interface is configured to transmit data between the external environment of the system and the adapter card.

In some embodiments, the adapter card 1200 is a peripheral component. The peripheral component facilitates communication between a system and an external environment via an optical transceiver (e.g., the communication interface 1206). The system comprises a motherboard (e.g., the motherboard 102, the motherboard 202, the motherboard 800, etc.) associated with the device. The external environment is an environment external to the system. In some embodiments, the peripheral component is of a substantially mini PCI express form factor. The system may further comprise a mini PCI express interface configured to couple the peripheral component to the motherboard. The mini PCI express interface is configured to communicate data between the peripheral component and the motherboard. The mini PCI express interface is configured to supply power to the peripheral component.

In some embodiments, a portion of the peripheral component extends beyond the mini PCI express form factor. In some embodiments, the peripheral component comprises an operating mode detection unit configured to determine an operating state of the motherboard, as described herein. In some embodiments, the peripheral component is configured to determine whether to perform a wake on local access network (WoL) operation, as described herein.

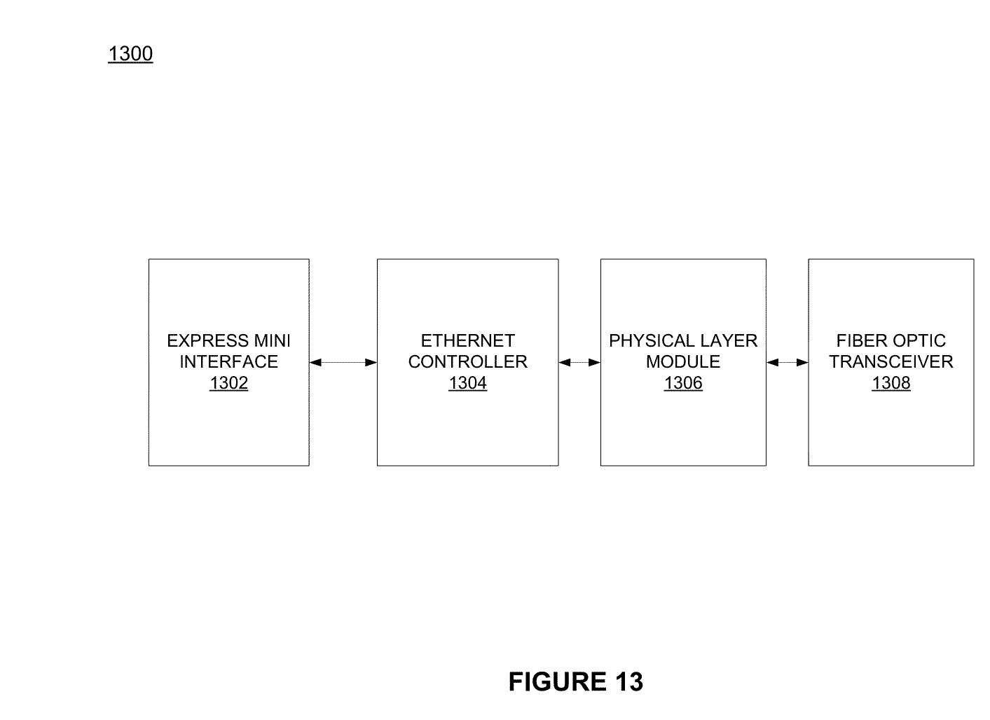

FIG. 13 shows illustrative components of an adapter card in accordance with some embodiments. FIG. 13 depicts components of an adapter card for interfacing with a mini PCI express slot and allowing communication with a fiber optic network. Diagram 1300 includes a mini PCI express or express mini interface 1302, an Ethernet controller 1304, a physical layer (phy) module 1306, and a fiber optic transceiver 1308.

The express mini interface 1302 is configured for interfacing with a mini PCI express slot, port, etc., of a motherboard (e.g., the motherboard 102, the motherboard 202, etc.). In some embodiments, the express mini interface 1302 is configured to convert mini PCI express signals, received from a motherboard, to PCI express signals.

The Ethernet controller 1304 is configured for facilitating Ethernet communications. For example, the Ethernet controller 1304 may facilitate communications for levels higher than the link layer. The physical layer (phy) module 1306 is configured for allowing physical access to the link layer. In some embodiments, the physical layer module 1306 couples the Ethernet controller 1304 to the physical medium via the fiber optic transceiver 1308. The fiber optic transceiver 1308 is configured for optical communications via fiber optic cables.

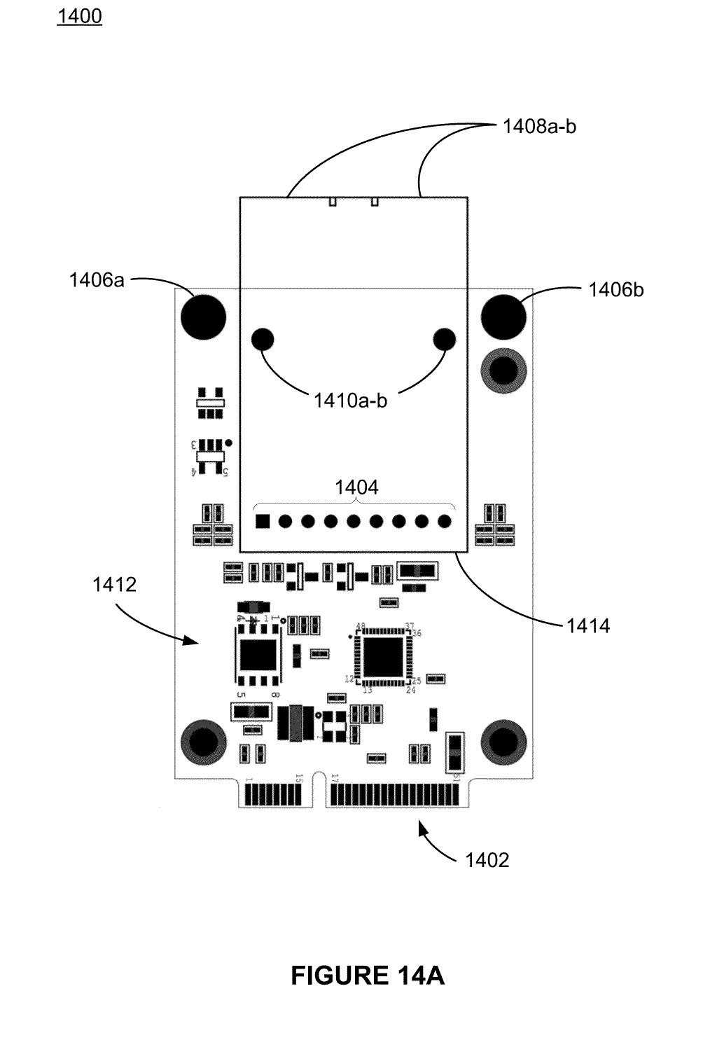

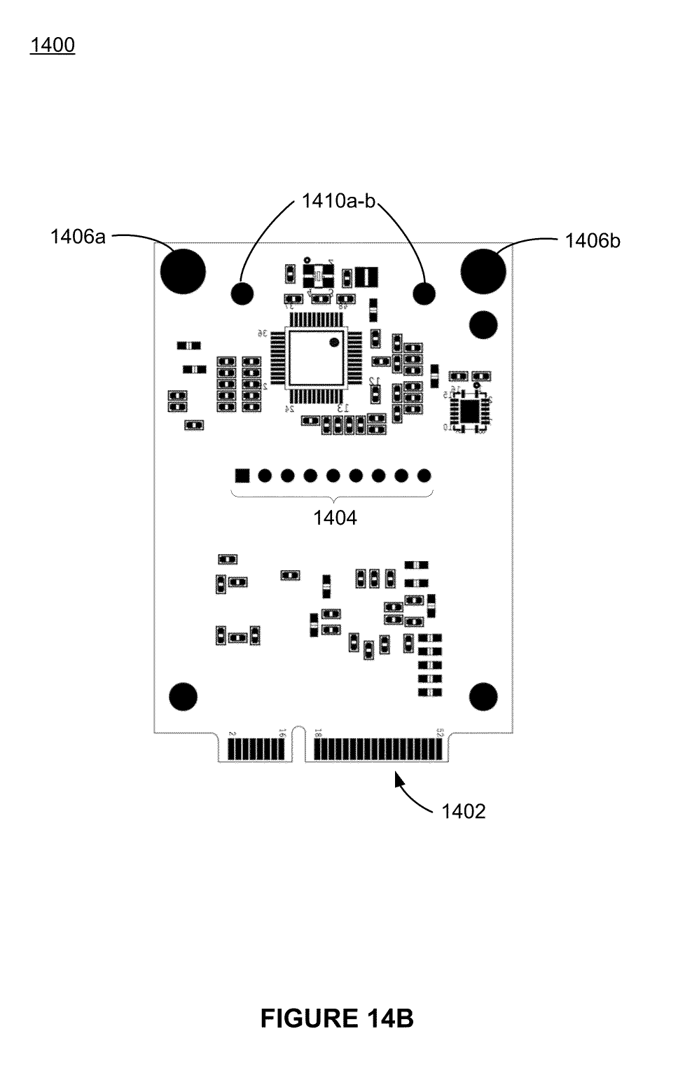

FIG. 14A shows an illustrative top view of an adapter card layout in accordance with some embodiments. FIG. 14A depicts the illustrative components of an adapter card 1400 configured for allowing fiber optic communication via a mini PCI express interface. The adapter card 1400 includes an interface 1402, interface pins 1404, mounting areas 1406a-b, ends 1408a-b, support pins 1410a-b, modules 1412, and a network data transceiver module 1414. FIG. 14B shows an illustrative bottom view of an adapter card layout in accordance with some embodiments.

The interface 1402 is configured for coupling adapter card 1400 to a motherboard (e.g., the motherboard 102, the motherboard 202, etc.). In some embodiments, the interface 1402 is a mini PCI express or express mini interface.

The mounting areas 1406a-b are configured for physically coupling, mounting, etc., the adapter card 1400 to a slot (e.g., a mini PCI slot). In some embodiments, the mounting areas 1406a-b includes holes configured for coupling to, interfacing with, etc., standoffs of a motherboard. For example, the standoffs of a motherboard may be configured for structurally supporting a mini PCI express card such as adapter card 1400.

The ends 1408a-b are configured for coupling of one or more communications apparatuses. For example, the ends 1408a-b may be configured for coupling of fiber optic cables for interfacing with an external socket (e.g., external socket 1406). In some embodiments, the ends 1408a-b are substantially similar to the ends 308a-b or the ends 908a-b.

The modules 1412 are configured for processing of electrical, data, and optical signals to facilitate communication between interface 1402 and the ends 1408a-b.

The support pins 1410a-b are configured for coupling of the network data transceiver module 1414 to the adapter card 1400. The network data transmitter module 1414 is configured for facilitating communication between adapter card 1400 and an external environment (e.g., LAN, the Internet, etc.). In some embodiments, the network data transceiver module 1414 includes an optical transceiver configured for optical communication. In some embodiments, the network data transceiver module 1414 is substantially similar to the network data transmitter modules 214 and 914. The interface pins 1404 are configured for communicatively coupling of the network data transceiver module 1414 to the adapter card 1400.

It is appreciated that throughout the embodiments, discussion of a particular interface such as Express-mini has been for illustration purposes only and should not be construed as limiting the scope. For example, an M.2 interface may be similarly used. It is appreciated that using other types of interfaces such as the M.2 may or may not have WoL capabilities.

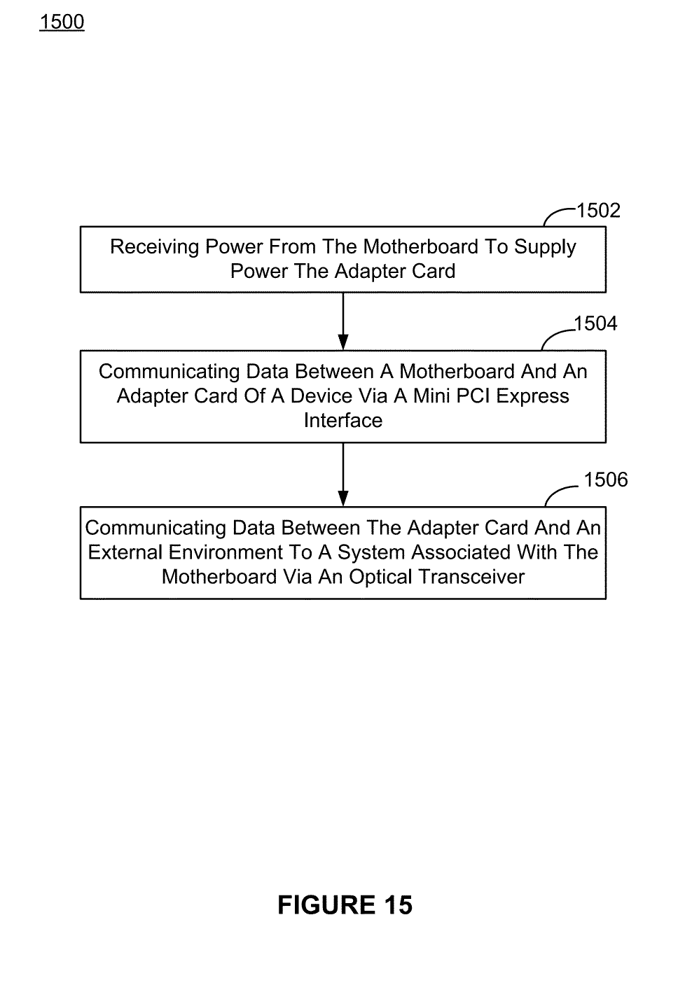

FIG. 15 an illustrative flow diagram for data communication of an adapter card in accordance with some embodiments. FIG. 15 depicts a process 1500 for communication via an adapter card (e.g., the adapter card 1200, the adapter card 800, the adapter card 108, the adapter card 208, etc.).

At block 1502, power from the motherboard to supply power the adapter card is received. In some embodiments, the adapter card has substantially a mini PCI express card form factor. In some embodiments, a portion of the adapter card extends beyond a standard mini PCI express card form factor. In some embodiments, the motherboard may be similar to the motherboards 102 and 202 of FIGS. 1 and 2, respectively.

At block 1504, data between a motherboard and an adapter card of a device via a mini PCI express interface is communicated. In some embodiments, the data may be for communication with an external environment.

At block 1506, data between the adapter card and an external environment to a system associated with the motherboard is communicated via an optical transceiver. In some embodiments, the communication may include emitting light signals to communicate networking data between the adapter card and the external environment.

In some embodiments, the process 1500 may further include determining an operating state associated with the motherboard and determining whether to perform a wake on local access network (WoL) operation based on the operating state. In some embodiments, the process 1500 may further include determining whether a first voltage or a second voltage is present at the motherboard coupled to the motherboard interface and initiating a wake on local access network (WoL) operation in response to determining the presence of the second voltage.

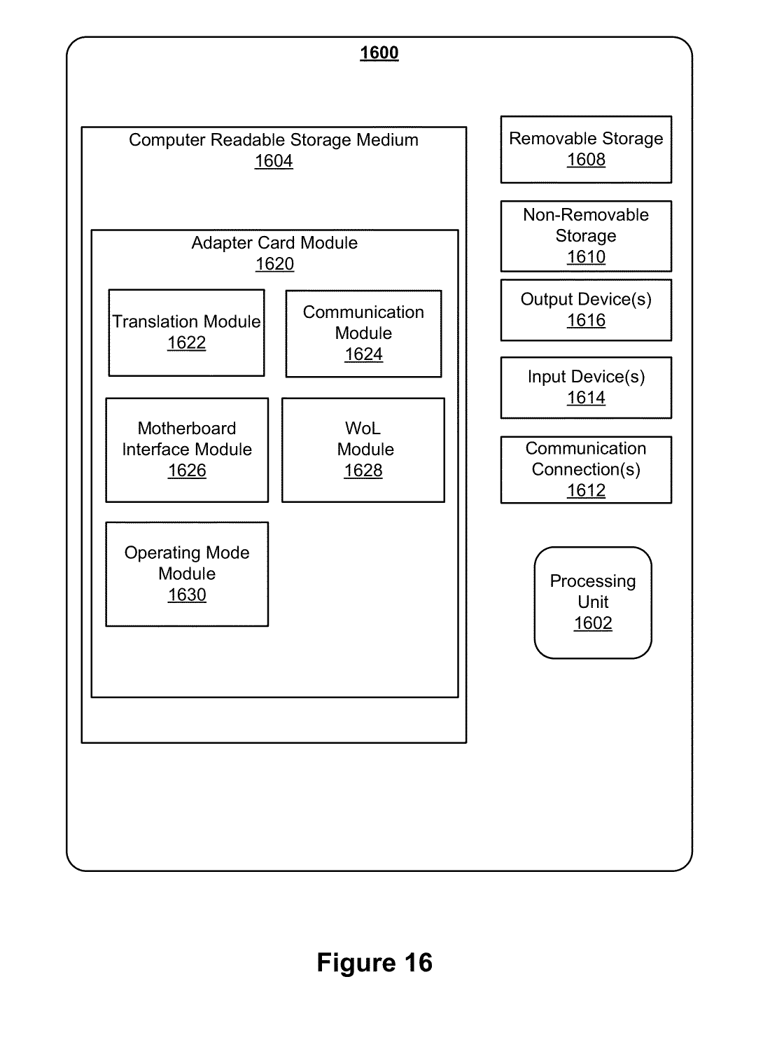

Referring now to FIG. 16, a block diagram of a computer system in accordance with some embodiments is shown. With reference to FIG. 16, an example system module for implementing embodiments disclosed above, such as the embodiments described in FIGS. 1-15. In some embodiments, the system includes a general purpose computing system environment, such as computing system environment 1600. The computing system environment 1600 may include, but is not limited to, servers, desktop computers, laptops, tablets, mobile devices, and smartphones. In its most basic configuration, the computing system environment 1600 typically includes at least one processing unit 1602 and computer readable storage medium 1604. Depending on the exact configuration and type of computing system environment, computer readable storage medium 1604 may be volatile (such as RAM), non-volatile (such as ROM, flash memory, etc.) or some combination of the two. Portions of computer readable storage medium 1604 when executed may perform name resolution and mapping functions to allow internal or private networks to use network addresses outside of private or internal network address ranges as specified by a network protocol.

Additionally in various embodiments, the computing system environment 1600 may also have other features/functionality. For example, the computing system environment 1600 may also include additional storage (removable and/or non-removable) including, but not limited to, magnetic or optical disks or tape. Such additional storage is illustrated by removable storage 1608 and non-removable storage 1610. Computer storage media includes volatile and nonvolatile, removable and non-removable media implemented in any method or technology for storage of information such as computer readable instructions, data structures, program modules or other data. Computer readable medium 1604, removable storage 1608 and nonremovable storage 1610 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by the computing system environment 1600. Any such computer storage media may be part of the computing system environment 1600.

In some embodiments, the computing system environment 1600 may also contain communications connection(s) 1612 that allow it to communicate with other devices. Communications connection(s) 1612 are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Communications connection(s) 1612 may allow the computing system environment 1600 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that the communication connection(s) 1612 connect to may run a plurality of network protocols including, but not limited to, transmission control protocol (TCP), user datagram protocol (UDP), Internet Protocol (IP), real-time transport protocol (RTP), real-time transport control protocol (RTCP), file transfer protocol (FTP), and hypertext transfer protocol (HTTP).

In further embodiments, the computing system environment 1600 may also have input device(s) 1614 such as keyboard, mouse, a terminal or terminal emulator (either directly connected or remotely accessible via telnet, SSH, HTTP, SSL, etc.), pen, voice input device, touch input device, remote control, etc. Output device(s) 2016 such as a display, a terminal or terminal emulator (either directly connected or remotely accessible via telnet, SSH, HTTP, SSL, etc.), speakers, LEDs, etc. may also be included.

In some embodiments, the computer readable storage medium 1604 includes an adapter card module 1620. The adapter card module 1620 is configured for facilitating and/or handling various functions, described above, of an adapter card (e.g., the adapter card 800, the adapter card 900, the adapter card 1200, and the adapter card 1400). The adapter card module 1620 includes a translation module 1622, a communication module 1624, a motherboard interface module 1626, a wake on local area network (WoL) module 1628, and an operating mode module 1630.

The translation module 1622 for translating, bridging, etc., communications between the motherboard interface module 1626 and the communication module 1624. In some embodiments, the translation module 1622 may perform or facilitate functions of translation module 1204 of FIG. 12. The communication module 1624 is configured for facilitating communication of the adapter card module 1620 with an external environment. In some embodiments, the communication module 1624 may perform or facilitate functions of communication interface 1206 of FIG. 12.

The motherboard interface module 1626 is configured for facilitating communication of an adapter card e.g., the adapter card 800, the adapter card 900, the adapter card 1200, and the adapter card 1400) and a motherboard (e.g., the motherboard 102, the motherboard 202, etc.). In some embodiments, the motherboard interface module 1626 may perform or facilitate functions of motherboard interface 1202 of FIG. 12.

The wake on local area network (WoL) module 1628 is configured to determine whether to perform a WoL operation and/or perform a WoL operation in response to receiving a voltage, as described herein. In some embodiments, the WoL module 1628 is configured to perform or facilitate performance of the functions of WoL unit 406, as described in FIG. 4.

The operating mode module 1630 is configured to determine whether a motherboard (e.g., the motherboard 102, the motherboard 202, etc.) is in an on state or an off state, as described herein. In some embodiments, the operating mode module is configured to perform or facilitate performance of the functions of operating detection unit 216, operating detection unit 500, etc.

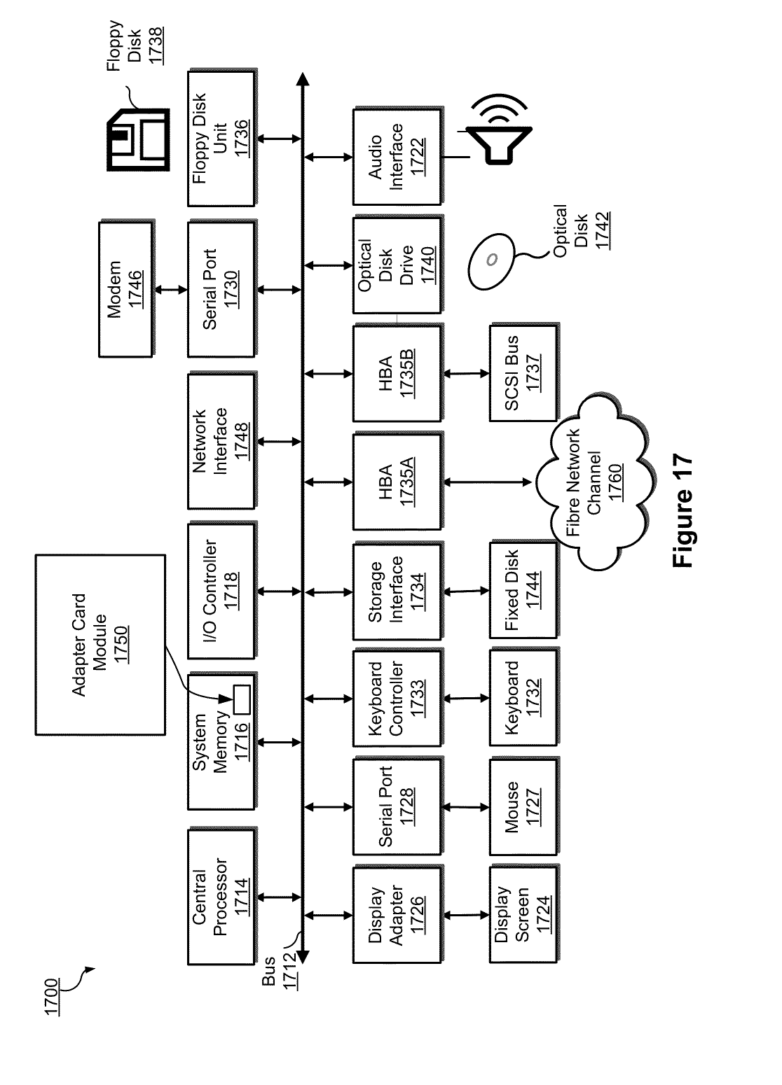

Referring now to FIG. 17, a block diagram of another computer system in accordance with some embodiments is shown. FIG. 17 depicts a block diagram of a computer system 1700 suitable for implementing the present disclosure. Computer system 1700 includes a bus 1712 which connects the major subsystems of the computer system 1700, such as a central processor 1714, a system memory 1716 (typically RAM, but which may also include ROM, flash RAM, or the like), an input/output controller 1718, an external audio device, such as a speaker system 1720 via an audio output interface 1722, an external device, such as a display screen 1724 via a display adapter 1726, serial ports 1728 and 1730, a keyboard 1732 (interfaced with a keyboard controller 1733), a storage interface 1734, a floppy disk drive 1736 operative to receive a floppy disk 1738, a host bus adapter (HBA) interface card 1735A operative to connect with a Fibre Channel network 1760, a host bus adapter (HBA) interface card 1735B operative to connect to a Small Computer System Interface (SCSI) bus 1737, and an optical disk drive 1740 operative to receive an optical disk 1742. Also included are a mouse 1727 (or other point-and-click device, coupled to bus 1712 via serial port 1728), a modem 1746 (coupled to bus 1712 via serial port 1730), and a network interface 1748 (coupled directly to bus 1712).

It is appreciated that the network interface 1748 may include one or more Ethernet ports, wireless local area network (WLAN) interfaces, etc., but is not limited thereto. System memory 1716 includes an adapter card module 1750, which is configured for facilitating various communication functions including operating mode detection, WoL, network communications, etc., as described herein.

According to some embodiments, the adapter card module 1750 may include other modules for carrying out various tasks (e.g., modules of FIG. 16). It is appreciated that the adapter card module 1750 may be located anywhere in the system and is not limited to the system memory 1716. As such, residing within the system memory 1716 is merely an example and not intended to limit the scope of the embodiments. For example, parts of the adapter card module 1750 may be located within the central processor 1714 and/or the network interface 1748 but are not limited thereto.

The bus 1712 allows data communication between the central processor 1714 and the system memory 1716, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS), which controls basic hardware operation such as the interaction with peripheral components. Applications resident with computer system 1700 are generally stored on and accessed via a computer readable medium, such as a hard disk drive (e.g., fixed disk 1744), an optical drive (e.g., optical drive 1740), a floppy disk unit 1736, or other storage medium. Additionally, applications can be in the form of electronic signals modulated in accordance with the application and data communication technology when accessed via network modem 1746 or network interface 1748.

The storage interface 1734, as with the other storage interfaces of computer system 1700, can connect to a standard computer readable medium for storage and/or retrieval of information, such as a fixed disk drive 1744. A fixed disk drive 1744 may be a part of computer system 1700 or may be separate and accessed through other interface systems. The network interface 1748 may provide multiple connections to networked devices. Furthermore, a modem 1746 may provide a direct connection to a remote server via a telephone link or to the Internet via an Internet service provider (ISP). The network interface 1748 provides one or more connections to a data network, which may consist of any number of other network-connected devices. The network interface 1748 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, not all of the devices shown in FIG. 17 need to be present to practice the present disclosure. The devices and subsystems can be interconnected in different ways than shown in FIG. 6. Code to implement the present disclosure can be stored in computer-readable storage media such as one or more of system memory 1716, fixed disk 1744, optical disk 1742, or floppy disk 1738. The operating system provided on computer system 1700 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings.

What is claimed is:

1. A device comprising:
an adapter card, wherein the adapter card comprises an optical transmitter;
a motherboard interface for coupling the adapter card to a motherboard, wherein the motherboard interface is configured to transmit data between the adapter card and the motherboard, and wherein the motherboard interface is configured to supply power from the motherboard to the adapter card, and wherein the motherboard interface is a mini PCI express interface; and
an external interface for coupling the adapter card to an external environment of a system associated with the motherboard, and wherein the external interface is configured to transmit data between the external environment of the system and the adapter card.

2. The device of claim 1, wherein the adapter card is configured for communication via a fiber optic cable.

3. The device of claim 1, wherein the optical transmitter is a portion of an optical transceiver of the adapter card.

4. The device of claim 1, wherein the adapter card has substantially a Mini PCI express card form factor.

5. The device of claim 4, wherein a portion of the adapter card extends beyond a standard mini PCI express card form factor.

6. The device of claim 1, wherein the adapter card comprises:
a network data transmitter module configured to communicate networking data between the external environment of the system and the adapter card via emitting light signals.

7. The device of claim 1, wherein the adapter card comprises an operating mode detection unit configured to determine an operating state of the motherboard.

8. The device of claim 1, wherein the adapter card is configured to determine whether to perform a wake on local access network (WoL) operation.

10. The device of claim 8, wherein the adapter card is configured to determine whether the motherboard is in an on state or an off state, and wherein the adapter card is further configured to initiate the wake on local access network (WoL) operation in response to determining that the motherboard is in the off state.

11. A method comprising:
receiving power from a motherboard to supply power an adapter card;
communicating data between the motherboard and the adapter card of a device via a mini PCI express interface; and
communicating data between the adapter card and an external environment to a system associated with the motherboard via an optical transceiver.

12. The method of claim 11, wherein the adapter card has substantially a Mini PCI express card form factor.

13. The method of claim 12, wherein a portion of the adapter card extends beyond a standard mini PCI express card form factor.

14. The method of claim 11 further comprising:
emitting light signals to communicate networking data between the adapter card and the external environment.

15. The method of claim 11 further comprising:
determining an operating state associated with the motherboard; and
determining whether to perform a wake on local access network (WoL) operation based on the operating state.

16. The method of claim 11 further comprising:
determining whether a first voltage or a second voltage is present at the motherboard coupled to a motherboard interface; and
initiating a wake on local access network (WoL) operation in response to determining the presence of the second voltage.

17. A system comprising:
a peripheral component, wherein the peripheral component facilitates communication between a system and an external environment via an optical transceiver, wherein the system comprises a motherboard associated with the system, and wherein the external environment is an environment external to the system, wherein the peripheral component is of a substantially mini PCI express form factor; and
a mini PCI express interface configured to couple the peripheral component to the motherboard, wherein the mini PCI express interface is configured to communicate data between the peripheral component and the motherboard, and wherein the mini PCI express interface is configured to supply power to the peripheral component.

18. The system of claim 17, wherein a portion of the peripheral component extends beyond the mini PCI express form factor.

19. The system of claim 17, wherein the peripheral component comprises an operating mode detection unit configured to determine an operating state of the motherboard.

20. The system of claim 17, wherein the peripheral component is configured to determine whether to perform a wake on local access network (WoL) operation.
